(19) United States
(12) Patent Application Publication
(10) Pub. No.: US 2017/0253979 A1
(43) Pub. Date: Sep. 7, 2017

(54) SOLAR CHLORINE PRODUCTION MODULE "SCPM"

(71) Applicant: NASSER F MEHR, FORT LAUDERDALE, FL (US)

(72) Inventor: NASSER F MEHR, FORT LAUDERDALE, FL (US)

(21) Appl. No.: 15/061,374

(22) Filed: Mar. 4, 2016

(51) Int. Cl. C25B 1/26; C25B 1/00; H01G 9/20; C01B 7/03

(52) U.S. Cl. CPC C25B 1/26; C01B 7/03; C25B 1/003; H01G 9/20

(57) ABSTRACT

The “Solar powered chlorine producing module”, “SCPM”, is a multi-purpose invention. It is designed to provide daily use of chlorine and caustic soda for water and sewer treatment plants in municipalities throughout the world. This design reduces the operating cost of water and sewer plants in such a way that the initial capital cost will be captured within a few years.

This invention is designed to replace the chlorine producing plants which are expensive to build and costly to operate. They use enormous electric energy taken from already overloaded power grid.

This invention eliminates transporting chlorine, which is considered hazardous material from producing plant to end users' sites. In addition to safety, it also eliminates the liquefaction and transportation cost. Currently, the chlorine end users need storage facilities for hazardous chemicals, which will be eliminated by use of the “SCPM” system.

Numerous industries use chlorine in daily processing and productions. They could use this system at their own site. Unlike conventional chlorine productions that are built with constant capacity production for their entire life with high initial capital cost, this design is flexible to the chlorine needs of user facilities. A chlorine production plant with “solar powered chlorine producing modules” is flexible, expandable with minimum initial capital investment that is suitable for any chlorine consumer facility.

### BACKGROUND OF THE INVENTION

1. Field of the Invention

The present invention relates to “solar powered Chlorine producing module” known as “SCPM” and, more specifically, to design a chlorine producing plant at the site of the municipalities' water and sewer treatment plants or any other chlorine consumer industry.

2. Description of the Related Art

This invention utilizes the solar energy, a permanent, non-delectable and free source of energy. This invention is specifically designed to eliminate the dependence of new chlorine producing plant on power utility network. Chlorine and caustic soda (jointly) are among top ten chemical produced by chemical industries. Chlorine producing facilities, known as “chloric-alkali process plants” are one of the very high-energy consuming industry. Even partial elimination of conventional plants from power network lowers the stress of already overloaded power utility system.

3. The present invention “SCPM”, unlike the conventional plant, does not run by power from the grid and does not need all the related power installation of high voltage service, step down transformer, converter of A/C power to DC power, and heavy conductor to carry very high electric current to electrolysis cells. DC Power generated by solar panel directly feed to chlorine producing cells.

Any invention that eliminates or reduces the use of carbon base energy is advantageous to everyone. Reduction of dependence on oil imports and effects on the environment from burning fossil fuels are among the top benefits. More importantly though, and less discussed, is the fact that oil is a limited and deplete-able resource, one that is very valuable in the production of plastics, pharmaceutical, nylons, polyesters, pesticides and fertilizers, to name a few.

Chlorine production in the site of municipalities' water and sewer plants with this invention eliminates the handling, transportation and large storage facilities that are for chlorine, which is considered hazardous material.

The saving from this invention is large enough to pay off initial capital investment of plant within five to ten years.

Furthermore, the chlorine producing plant design with use of solar powered chlorine producing module, unlike the conventional plant, is environmental friendly. In this design, 2500 kWh of solar power will be used to produce one ton of chlorine. In conventional plant using utility power for each ton of chlorine, produced 5450 pounds of carbon dioxide will be released into the atmosphere by power plant, while CO₂ released by this invention is zero. The use of oil product to transport is eliminated.

Finally, this invention utilizes the membrane technology that is superior among the three popular electrolysis process of chlorine production due to its lowest energy need per ton of chlorine produced (very high quality products and friendliest process to environment).

### BRIEF SUMMARY OF INVENTION

In an effort to improve the deficiencies of conventional chlorine producing plants, first objective of this invention is to provide a design that utilizes the solar energy to power the chlorine producing cells.

The second objective of the present invention is to eliminate expensive electrical installation that receive high voltage A/C power from utility network, lower the voltage, and convert it from A/C to 3-volt DC current to power electrolysis cells.

The third objective of the present invention is to eliminate the power loss in electrical installations and conversion.

The fourth objective of this invention is to decrease stress on the electric network by eliminating high-energy users.

The fifth objective of this invention is to eliminate rigidity in production and high initial capital cost of traditional plants by use of solar powered chlorine producing module “SCPM”.

The sixth objective of the present invention is to eliminate transportation and storage of hazardous material on our roads and in the cities.

It is a seventh objective of the present invention to use the membrane technology that has the lowest consumed energy the highest quality products. It is also most friendly process to the environment.

It is a further objective of the present invention to use solar power and eliminate at least 2500 kWh from utility network for each ton of chlorine production that is equal to 5.9 barrel of crude oil not burned in power plants and less dependency to foreign oil.

Finally, it is an objective of the present design to reduce the pollutants, which result from burning of fossil fuel in power generating plant and transportation. Traditional method for each ton of chlorine produced, power plant releases 5450 pound of carbon dioxide while the emission of CO₂ from this invention is zero.

### SYMBOLS' DESCRIPTION

The following legend is provided at the opening of this section for easy reference when abbreviations are found throughout the detailed description section. Any abbreviation or symbols not in the legend are deemed to be known to those skilled in the art:
Cl₂ is chlorine gas, a molecule of chlorine with two atoms
Cl⁻¹ is ion of chlorine with negative charge of one electron
Na is one atom of metallic sodium
Na⁺¹ is one ion of sodium with a positive charge of one proton, equal to charge of one electron but positive charge
H₂ is hydrogen gas
H⁺¹ is ion of hydrogen.
e⁻¹ is one electron with negative charge of 1.6022×10⁻¹⁹ coulomb
Atom gram for any element, is the weight of 6.022×10²³ number atom of that substance in gram
Valence Gram is the atom gram of element divided by valence of that element
Valence is the degree of oxidation of element in chemical reaction. For example, Na⁺¹, Fe⁺², AL⁺³ are metals with 1, 2 and 3 valence, while Cl⁻¹, O⁻² and p⁻³ are non-metal of 1, 2 and 3 valence
Coulomb is the electric charge passing through a wire having one AMP current in duration of one second
Farad is the electric energy needed to break down one valence gram of compound to its elements. One farad is equal to 96,485 coulombs
Na CL is sodium chlorine or table salt
Na OH is sodium hydroxide known as caustic soda in the market
Psi is unit of pressure and is equal to pound per square inch
C Coulomb
V, KV is volts and 1000 volt of power source
I is the current of power
Anion is Ion with negative charge like Cl⁻¹, O⁻²
Cation is Ion with positive charge like Na⁺¹, Fe⁺²

### Science Behind

To describe this invention, it is important that the solar technology and chemistry science on topic of electrolysis process be explained, and Prior to a detailed description of the invention, the following subjects need to be covered.

A—Chemical science behind the electrolysis process, and popular methods in the chemical industry.
B—Science and technology of solar power.

Thereafter, the detailed description of invention becomes simpler and better understandable.

### A—CHEMICAL SCIENCE BEHIND THE ELECTROLYSIS PROCESS

What is chlorine?

Chlorine is a substance that does not exist in nature but is abundant in compound form of metal chloride like table salt everywhere.

Chemical Property:

In chemistry science, chlorine is known as a member of one of the five elements of the Halogen group in periodic table. Its abbreviated symbol is “Cl”. Its atomic number is 17, and its atomic weight is 35.453 grams, and molecular weight of 70.906 gram. Chlorine usually forms compounds with a valence of (−1), but it can compound with a valence of (+1), (+2), (+3), (+4), (+5) and (+7).

Physical Property:

Chlorine is a greenish-yellow gas at room temperature and atmospheric pressure. It has the following physical properties:
Melting point at atmospheric pressure (14.7 Psi) is −149.76° F. (−100.98° C.)
Boiling point at atmospheric pressure (14.7 Psi) is −29.15° F. (−33.97° C.)
Liquid state at room temperature of 60° F. has a pressure of 86.58 Psi
Specific gravity of Cl₂ respect to air at 32° F. and 14.696 Psi is 2.485 (note the density of dry air at the same condition is 1.2929 Kg/m³
Specific gravity of Cl₂ liquid at 32° F. respect to 4° C. water is 1.467
Specific volume of Cl₂ gas at 32° F. and 14.7 Psi is 4.986F+³/1b
Specific volume of liquid Cl₂ at 32° F. is 0.1092F+³/1b

### Use of Chlorine:

Chlorine, along with its byproduct, caustic soda, is among the top ten products in the chemical industry. The world's chlorine production in 2014 was 56 million tons. Europe and North America's share were 16 and 11 million tons respectively. Presently, most chlorine is produced off site of the user industry. By this invention, the cost to liquefy the chlorine, bottling and shipment is eliminated. However, for chlorine to be used in water and sewer plants, it needs to be dried by passing it through concentrated sulfuric acid, then compressed and liquefied into cylinders for transportation.

### Chlorine Production:

In chemistry lab, chlorine can be produced in many ways but in the chemical industry, chlorine is produced by a breakdown of the chlorine compound (most commonly known as table salt, (Na Cl) by electrolysis of brine

### Electrolyte:

A solution of acid or alkaline or salts in water is called electrolyte. Electrolyte is conductive due to ions from ionization of one of the above substance in water. Ions Cl⁻¹, So₄⁻² and O⁻² have negative charge and are known as “Anions”. Ions like H⁺¹, Na⁺¹, and Fe⁺² have positive charge and are labeled as “Cations”. In electrolyte, anions and cations are mixed together randomly and uniformly. When electrolyte solution is placed in electrostatic field, separation and orientation of ions will happen and anions go to anode while cations head toward cathode.

### Electrolysis:

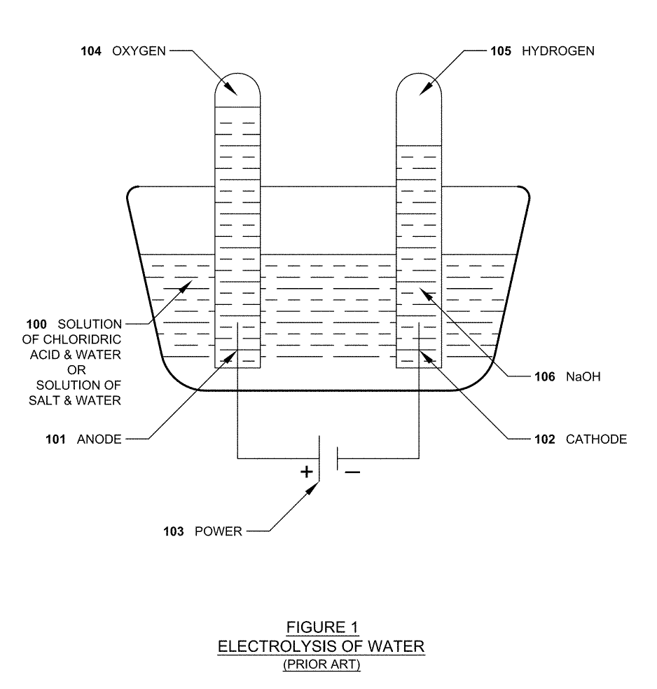

The process of separating the positive and negative ions in electrostatic field is called electrolysis. FIG. 1 shows the concept of electrolyze process in the laboratory. Electrolyte 100 is a solution of Cl Na in water or solution of chloric acid and water 100. Anode 101 and cathode 102 are connected to positive and negative of DC POWER 103, Cl₂, 104 or 02104 is collected in anode 101, H₂105 and NaoH106 in cathode 102. The Process is described in the following equations:

2ClNa→2Cl⁻¹+2Na⁺¹ in electrolyte

2Cl⁻¹→Cl2+2e⁻¹ in anode(Chlorine Gas)

2H2O [symbol] 2H⁺¹+2(OH)⁻¹ in cathode

2H⁺¹+2e⁻¹→H2 in cathode(Hydrogen Gas)

2Na⁺¹+2(OH)⁻¹→2NaoH in cathode(Caustic Soda)

### Electrolysis Energy:

In order to obtain chlorine, it is necessary to break the chemical bond of sodium and chlorine in salt solution by electric power input through the electrolysis process. One ion of chlorine (Cl⁻¹) has a negative charge equal to the charge of one electron. When one ion of chlorine (Cl⁻¹) is pulled toward anode, it will give up one electron to become one atom of chlorine gas.

The electrical energy to produce one atom gram of chlorine is given in “Coulomb” by the following equations:

[C] Energy (In Coulomb)=[Electric charge of one electron]×[Number of atoms in one atom gram of chlorine].

(C)=1.6022×10⁻¹⁹×6.022×10²³=96,485 coulomb.

### Where

1.6022×10⁻¹⁹ is negative charge of one electron

6.022×10²³ is Avogadro's No.=Number of atoms in one atom gram

1 Farad is 96,485 Coulomb

### Energy Input Per One Ton of Chlorine:

The theoretical input energy is calculated by the following equations,

C/1 ton Cl₂=(96,485)×(10⁶ gr/35.5 gr)=2.718×10⁹Coulomb/one ton Cl₂

C_{coulomb}=Iₐₘₚₛ×t_{sec} (Current×Time) or(Ampere×Second).

P_{watt}=V×I_{A}=V×C/t_{sec}

P_{watt}/ton=3.3^{v}×(2.718×10⁹Coulomb/ton Cl₂)

P_{KWH}=P_{watt}/(1000 watt/1 kw)×(3600 second/hour)

P_{KWH}=P_{watt}/3.6×10⁶ watt×second

P_{KWH}/ton=3.3^{v}×(2.718×10⁹ Coulomb/ton)/3.6×10⁶

P_{KWH}/ton=2492 KWH/one ton Cl₂

P_{KWH}/ton=2492 KWH/one ton Cl₂

In new membrane cells, the input energy per one ton of chlorine production is 2500 KWH.

### Industrial Chlorine Production:

Ninety-five percent (95%) of industrial chlorine production is by electrolysis of saturated salt solution. Now, three types of electrolysis cells, diaphragm cell, mercury cell, and membrane cell have been used extensively. The breakdown of brine is the same in all three, and their main difference is the manner by which their products are separated from the mixed and quality of the products.

### A—Diaphragm:

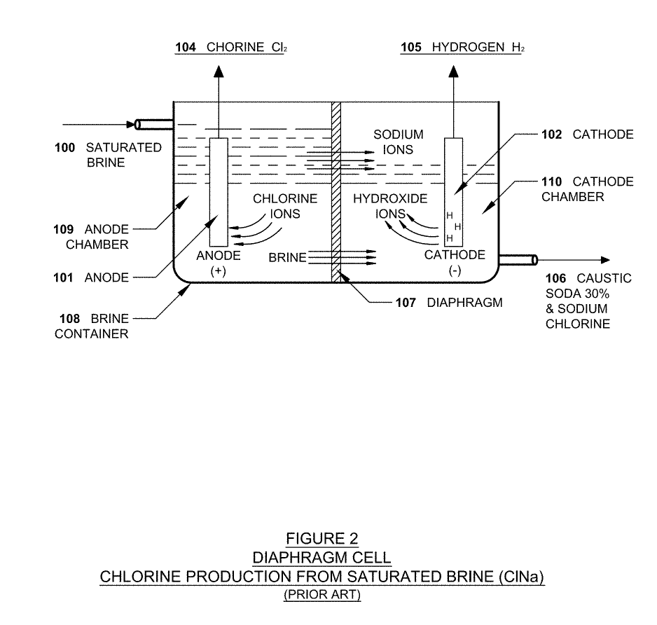

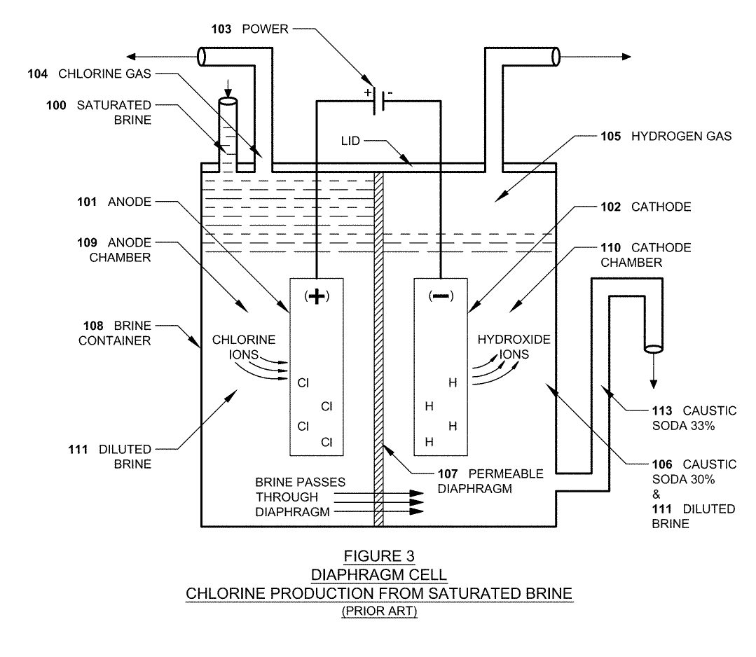

The diaphragm cell per FIG. 2 and FIG. 3 is made of brine Container 108 and permeable Diaphragm 107 that divides the Container 108 into anode Chamber 109 and cathode Chamber 110.

The saturated Brine 100 enters to anode Chamber 109 from the top. Brine elevation in anode Chamber 109 is higher than cathode Chamber 110 and create pressure drop across the permeable Diaphragm 107 to facilitate the movement of Brine 100 through Diaphragm 107 toward the Cathode 102. In anode Chamber 109, ion of Cl⁻¹ goes to Anode 101, and give up its electron and leaves anode as Chlorine gas 104 per FIG. 1, FIG. 2 and FIG. 3 and the following equation.

2Cl⁻¹→Cl₂+2e⁻¹

In cathode Chamber 110, water will be ionized to H⁺¹ and OH⁻¹. Ion of H⁺¹ receives one electron and as H2 gas 105 leaves the Cathode 102, and ion of OH⁻¹ combines with ion of Na⁺¹ to produce Na OH 106.

FIG. 2 and FIG. 3 show the reactions in cathode chamber per the following:

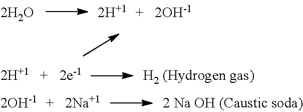

In addition, in cathode Chamber 110, the ion of Na⁺¹ reaches the cathode, 102 receive the missing electron to become metallic sodium. Metallic sodium reacts with water and produce caustic soda 106 and hydrogen gas 105 according to the following equations.

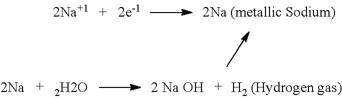

In the diaphragm, process chlorine gas 104 is collected at the top of anode Chamber 109, and hydrogen gas 105 is collected at the top of Cathode Chamber 110.

The leaving solution 106 from cathode Chamber 110 contains about 10 to 12% Na OH (caustic soda) and 15% of Na Cl. By evaporation of diluted caustic soda 106 with steam and reduced its volume to 20% of original volume, when sodium chloride (Na Cl) crystallized and separates. The remaining solution containing 50% caustic soda and less than 1% Na Cl becomes marketable. However, the non-purified caustic solution 106 is suitable for 80% of market demand.

### B—Membrane Cell:

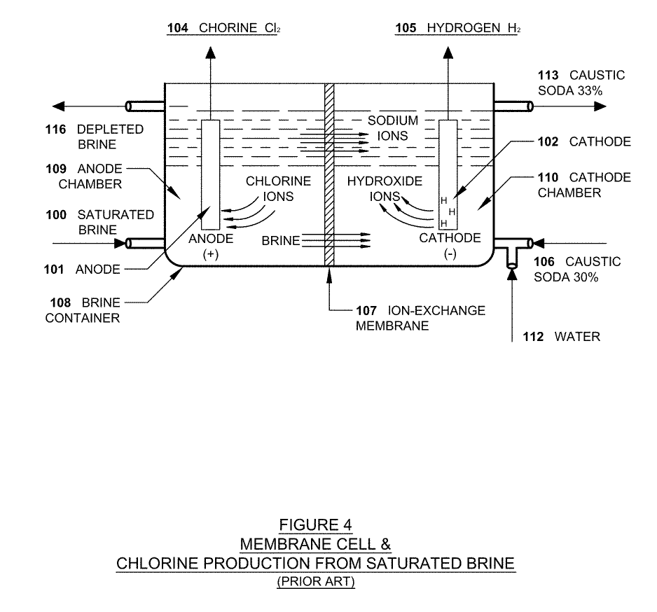

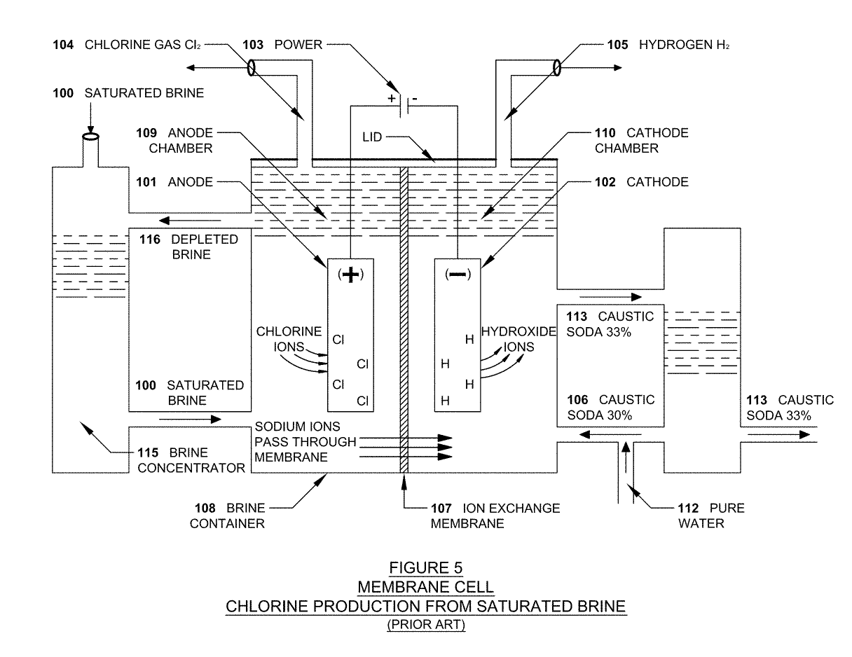

FIG. 4 and FIG. 5 explain the ions orientation and chemical reaction in membrane cell. A non-permeable ion exchange membrane 107 divides the cell 108 into anode Chamber 109 and cathode Chamber 110. Membrane 107 allows only the cation to pass through.

Anode Chamber 109 includes anode 101 that is connected to positive pole of power source 103. Saturated brine 100 enters in the lower part of the chamber. As it moves upward, it gives up its ions and anion Cl⁻¹ attracts to anode 101, gives one electron to anode and as chlorine gas 104 is collected at the top of Chamber 109, depleted brine 116 leaves at the top of Chamber 109 to Brine concentrator 115.

Cathode chamber 110 has cathode 102 connected to negative power source 103. Cathode Chamber 110 receives cation Na⁺¹ from membrane 107. Diluted caustic soda 106 by pure water 112 enters at the lower part of the chamber 110 moves up and gains additional “Na OH” becomes concentrated 33% caustic ˜113 when it leaves the cathode chamber 110.

FIG. 4 and FIG. 5 show the movement of ions and chemical reactions. In anode chamber 109, chlorine gas CL₂104 produces from anion Cl⁻¹ per the following equation.

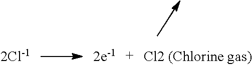

In cathode chamber 110, hydrogen gas H₂ 105 and sodium hydroxide (Na OH) 113 will be produced per the following reactions.
a—In cathode 102 water molecules polarized and ionized with cathode's excess electrons.

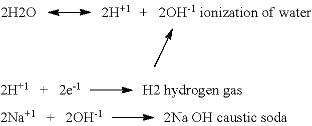

b—Cation Na⁺¹ reaches cathode 102, receives one electron, becomes Metallic Sodium that reacts with water to produce hydrogen gas 104 and Caustic soda 113.

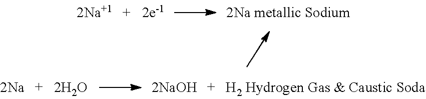

### C—Mercury Cell:

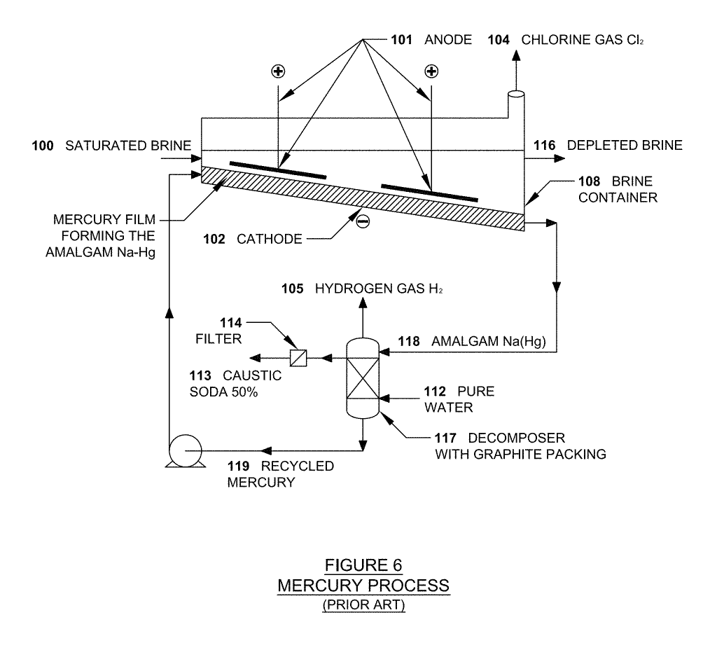

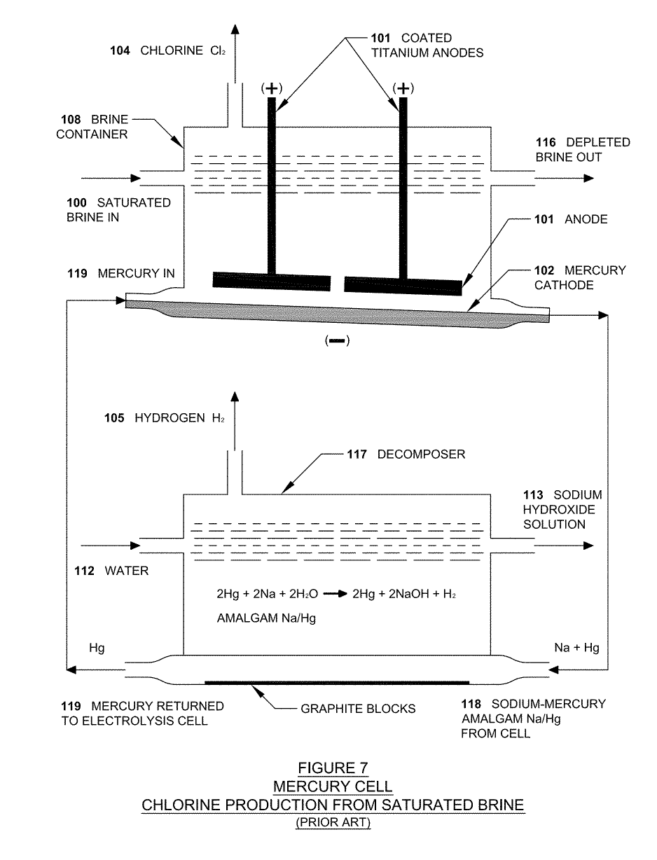

FIG. 6 and FIG. 7 show the schematic of mercury cell. It has a spread of mercury at the sloped bottom of the cell as cathode 102. A row of metallic plates located at close distance of mercury surface act as anode 101. The anodes and cathode share one chamber. Saturated brine 100 enter at the top at the level of the anode plates, and depleted brine 116 leaves at a level slightly higher than brine entry 100. Negative power pole is connected to mercury cathode 102 through the bottom plate. Due to uniformity of electro-static field between cathode 102 and anode 101, mercury cells are able to operate with higher current density as high as five and three times of the diaphragm and membrane respectively. In addition, the applied voltage can be 20% higher than the others can. For this reason, mercury cells have higher production per unit volume. Per FIG. 6, as saturated brine 100 enter cell 108, anion Cl⁻¹ attracts to the anode, strips its electron and at the top of the cell as chlorine gas 104. Cation Na⁺¹ go to mercury, receives electron and becomes metallic sodium (Na). In cathode 102, mercury forms “Na—Hg Amalgam” 118 that leaves the cell 108 to amalgam decomposer 117. As FIG. 7 shows, in decomposer 117, the amalgam comes in contact with ionized water 112. It reacts with water and breaks down per the following equations.

2H₂O [symbol] 2H⁺¹+2OH⁻¹

2H⁺¹+2e⁻¹→H₂(Hydrogen gas)

2OH⁻¹+2Na—Hg→2NaOH+2Hg(Caustic Soda & Metallic Mercury)

In decomposer unit 117, hydrogen gas 105 will be collected at top of decomposer 117, regenerated mercury 119 recycles back to mercury cell 108, and caustic soda solution 113 goes to further purification if it is needed. Mercury cell caustic has the higher quality than the products of the other two Cells that was previously mentioned. However, there is 0.2 to 3 grams of mercury pollutant per each ton of chlorine.

### Specification of Chlorine Cells

The following table is the summary of the cell's specifications. It helps in better understanding and proper cell selection.

| | | MERCURY | DIAPHRAGM | MEMBRANE |
|---|---|---|---|---|
| | DESCRIPTION | CELL | CELL | CELL |
| 1 | Theoretical | 3.15 | 2.19 | 2.19 |
| | Voltage (V) | | | |
| 2 | Current density | 8 to 13 | 0.9 to 2.6 | 3 to 5 ⁽¹⁾ |
| | (KA/m2) | | | |
| 3 | Cell voltage (V) | 3.9 to 4.2 | 2.9 to 3.5 | 3 to 3.6 |
| 4 | Caustic strength | 50% | 12% | 33% |
| | (% by weight) | | | |
| 5 | KWH of AC/one | 3360 | 2720 | 2650 ⁽²⁾ |
| | ton of chlorine | | | |
| | in | | | |
| 6 | Current density | at 10 KA/m2 | at 1.7 KA/m2 | at 5 KA/m₂ |
| | of KA/m2 | | | |
| 7 | Electric energy | 200 | 250 | 140 |
| | used by other | | | |
| | equipment | | | |
| | (Compressor, | | | |
| | Pumps,) | | | |
| | ACKWH/ | | | |
| | ton of Cl₂ | | | |
| 8 | Total energy | 3560 | 2970 | 2790 |
| | used | | | |
| | (ACKWH/ | | | |
| | ton C1₂) | | | |
| 9 | Energy used by | 0 | 610 | 180 |
| | steam to | | | |
| | concentrate | | | |
| | caustic soda to | | | |
| | 50% (ACKWH/ | | | |
| | ton Cl₂) | | | |
| 10 | Adjusted total | 3560 | 3580 | 2970 |
| | energy | | | |
| | (ACKWH/ | | | |
| | ton Cl₂ | | | |
| 11 | Caustic quality | High | 1-1.5% Cl Na | High: <50 ppm |
| | | 2.5-25 mg of | by weight after | Cl Na |
| | | Hg/Li Pollutant | treatment | |
| 12 | Chlorine quality | <0.1% of | 1.5-2.5% | 0.5-2% |
| | | O₂ & H₂ | oxygen | depending on |
| | | Oxygen & | | acidity of brine |
| | | hydrogen | | |
| 13 | Requirement of | Some High | Some High | Very High |
| | purification of | | | |
| | brine | | | |
| 14 | Variable electric | 30% of full | slightly | 40-60% |
| | load | load possible | variable | full load |
| | performance | | | |
| 15 | Construction cost | expensive | relatively cheap | cheaper than |
| | | | | mercury |
| 16 | Operation | toxic Hg must | frequent | low |
| | | be removed | asbestos | maintenance |
| | | from effluent | replaced | cost |

⁽¹⁾ Current density of 5 KA/m2 uses more energy but increase production. High density creates more heat. Warmer caustic and less steam is required.
⁽²⁾ New membrane for first two years uses 2575 KWH/ton of chlorine.
3 - The heat lease from one-ton steam when condensed in concentrator Unit is equal to 250 KWH.

### Selection of Electrolysis Cell for this Invention

After study of science behind the electrolysis and three popular chlorine-producing cells, the membrane technology has been selected with the following considerations.
1—Pollution to environment: mercury cell releases 0.2 to 3.0 gram of mercury per ton of chlorine as pollutant. Diaphragm cells are made by spray of asbestos over metal mesh that contributes pollution when it is made or replaced.
   Membrane is environmental friendly.
2—Energy use: Among the three cells, the membrane has the lowest KWH used to produce one ton of chlorine.
3—Power voltage fluctuation: up to 40% does not affect the membrane's performance.
4—High quality product: Membrane products of Cl₂, H₂, Na OH are high quality and can be used directly without further purification.
5—Low capital investment: The membrane cell has low capital investment, low operating cost, the lesser environmental impact, and it is the best available technology (Bat).
   In “solar chlorine producing module”, “SCPM”, the subject of this invention, the membrane has been selected for chlorine production.

### B—SCIENCE AND TECHNOLOGY OF SOLAR POWER

Solar cell is a diode of semi-conductors that generate electric energy when irradiated by the sun's rays. Solar cells are often electrically connected and encapsulated as a panel that have a sheet of glass on the sun's side allowing the light to pass while protecting the semi-conductors from rain, hail and other elements. In solar panel, cells are connected in series for voltage increase and in parallel for current increase. An array is a group of cells that are electrically connected in parallel and series with desire DC voltage and current. The power output of solar array is measured in watts or kilowatts. To calculate the energy needed for an application, a measurement of KHW per day is often used. A common rule of thumb is that the average power over 24 hours is equal to 20% of pick power, so the solar panel energy production in 24 hours is equal to production of same panel with peak power in five (5) hours. The solar generated energy most often is fed into power utility network by using inverters. In stand-alone systems, batteries are used to store the energy that is not needed immediately.

### Solar Cell Efficiency:

Solar cell's “energy conversion efficiency” is the ratio of power converted to electricity divided by solar energy irradiated to solar cell's surface. The efficiency is calculated by the ratio of the maximum power point, (Pm_{watt}) of panel with area of Ac, (meter squared, M2) divided by the total panel sunlight power. The total panel sunlight power, P_{sunlight}, is the sunlight power irradiance E, (E_{WATT}/M²) on panel area of Ac under standard test conditions (STC), per equation (1.)

$$= \frac{{Pm}^{w}}{E w \text{/} {m}^{2} \times {Ac}^{m 2}} \qquad ( 1 )$$

Standard test condition is temperature of 25° C., irradiance of E=1000 w/M², and air mass of “A M 1.5” spectrum.

### Air Mass Spectrum:

The Air mass number varies, it dependent on geographic location, altitude, sun location and elevation. It varies with time of the day and with seasons of the year, it could have any value and because of that, it called AM spectrum.

For a path length “L” through the atmosphere for solar radiation incident at angle “Z” relative to the normal to the earth's surface, the air mass coefficient is;

AM=L/L₀=1/Cos Z°

### Where;

“L₀” is the Zenith path length (Atmosphere vertical length at the sea level).
“Z” is the Zenith Angle in degree.
For sun at angle “Z=48.19°.”

### AM=1/Cos 48.19°=1/0.66666=1.5 AM

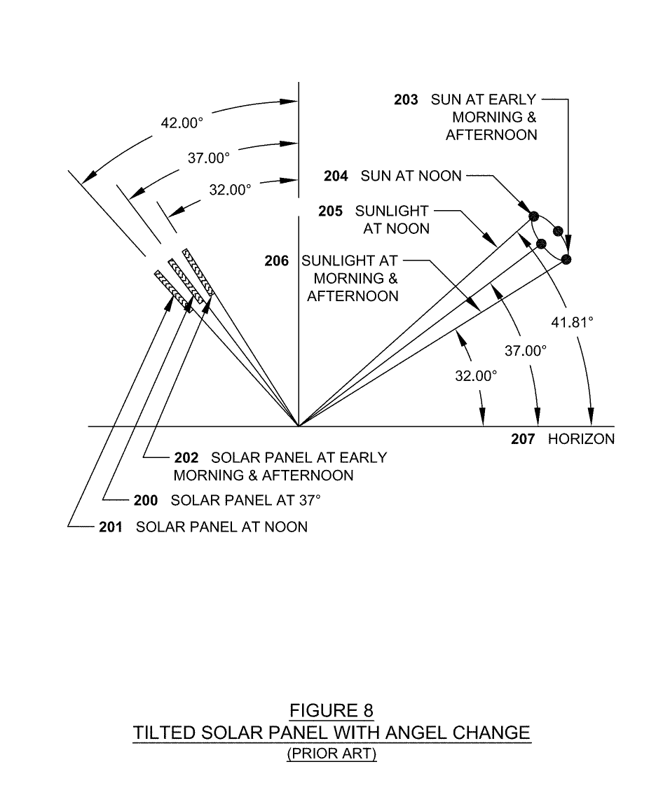

FIG. 8 depicts the irradiance and spectrum of sunlight incident of the surface of the solar panel 200 tilted 37° and sunlight at noon 205 at an angle of 41.81° above horizon. This condition represents almost the solar position near the vernal equinox and autumnal equinox in the continental United States, in clear day. The sun's irradiance energy will be 1000 w/M². IN this condition, if the solar cell's power point is 150 watts then the efficiency of this cell is (150 w/1000^{w} or 15%.

### Maximum Power Point:

A solar cell may operate over a wide range of voltage (V) and current (I) depending on the resistance of connected circuit. Circuit with zero resistance (short circuit condition) voltage is zero. Current is max called “I_{sc}” when circuit resistance increases to infinity (open-circuit), voltage has the highest value called “V_{oc}” and current is zero. At those two ends of resistance spectrum, solar power generated is zero, and will have value when both voltage and current have no-zero values. With certain circuit resistance, the power generated is max. This is known as power point (Pm).

### Silicon Cell Max Voltage:

A high quality mono-crystalline solar silicon cell may produce 0.6 volts (V₀) at cell temperature of 25° C. In ambient temperature of 25° C. and full sum, the temperature of irradiated cell will be about 45° C. This higher temperature reduces the voltage V_{oc} to 0.55 volts per each cell.

### Maximum Power Point:

At an ambient of 25° C. and silicon cell working temperature of 45° C., the maximum power is produced with voltage of 75% to 80% V_{oc} (say 0.43 volts) and the current is 90% of I_{sc} (short-circuit). Therefore, the maximum power point (Pm) is about 70% of “V_{oc}×I_{sc}”.

Low quality cells have more rapid voltage drop with current increase and its power point voltage is 50% of Voc. Its current is 50% I_{sc}, and the power point could drop from 70% of V_{oc}×I_{sc} to 50% or even 25%.

### Solar Cell Selections:

Use of power point (V_{oc}×I_{sc}) in solar cell alone as a guide in solar cell selection is misleading and insufficient. However, full spectrum of power generation curve with current increase should be considered.

### Solar Cell Fill Factor (FF):

The ratio of summation of power spectrum correspond to current from zero (Iₒ) to (I_{sc}), that is the area under power curve (in plot of power versus current), to power point of V_{oc}×I_{sc} is called Fill Factor. Fill Factor is useful in cell selection.

$$FF = \frac{Pm}{{V}_{oc} \times {I}_{sc}} \qquad ( 2 )$$

From equation 1, substitute, (Pm=m×E×Ac) in to equation (2)

$$FF = \frac{\times Ex Ac}{{V}_{co} \times {I}_{sc}}$$

### Irradiance Effect on Power Production:

The short circuit current (I_{sc}) is nearly proportional to illumination intensity. Open-circuit voltage (V_{oc}) is less sensitive to illumination. By 80% drop of illumination there is only 10% drop in open-circuit voltage (V_{oc}).

### Range of Efficiency:

Solar cell efficiencies vary from 6% (amorphous silicon base) to 40.2% and 42.8% (multiple junctions in research laboratories).

### Commercial Sell:

Commercially available multi-crystalline silicon cells have efficiency of 14% to 19%.

The highest efficiency cells are not the most economical. Multi-junction cell with efficiency of 30% based on exotic materials such as “Gallium Arsenide” or “Indium Selenide” will cost 100 times of silicon cell with 8% efficiency and only produce four times the power.

### Cost of Generated Power by Solar Panel:

The price of delivered KWH is the way to justify the economic cost of power generated by solar cell. In cost analysis, the following dominating parameters should be considered:

1. Efficiency conversion of solar panel

2. Intensity of sun irradiation

3. The useful life of solar panel

4. Fill Factor (FF); the larger the number the better the cell

5. Curve of power versus current

The above parameters will lead to overall system selection between the choices.

### Cost of Solar Power Versus Conventional Power Plant:

With commercial silicon panel and efficiency of 8% to 19%, the cost of solar power in 2005 ranged from $0.6/kwh (Europe) down to $0.3/kwh (in regions with high sun irradiation). The large portion of above cost is due to cost of large conductors, low voltage DC power (direct current) to AC (alternative current) convertors, step up transformer, and synchronizing and metering equipment. Also in process of converting 30-volt DC power to AC, power with 20 kv volt (utility distribution voltage) over 30% of energy generated convert to heat as loss. Worldwide, the cost of conventional power plants in year 2005 was between $0-04/kwh to $0.25/kwh depending on plant size and fuel.

Based on above argument, it can be concluded that use of solar panel to feed power utilities network is not feasible.

Solar Power in this Invention:

Chlorine producing cells use low voltage DC power (3 volts). To provide such power from high voltage utility network requires installation of expensive electrical equipment to lower the voltage and convert it from AC to DC power. This process associates with power loss of 30% and more, but solar panels generate exact power that is consumed by chlorine producing cells.

In this case, the cost of delivering KWH to chlorine cell drops to less than $0.1/kwh that makes the use of solar power economically feasible.

Solar Cell Selection for this invention:

The solar cell technology is relatively spread in regards to:

1. Costs, solar cells have price from low to very high

2. Efficiency: the efficiency of solar cells ranges from 6% to 40%

3. Durability: resistance against severe elements and ultra violet

4. Life: useful life span

Considering the above parameters, crystalline silicon “C—Si” is a good choice. Crystalline silicon also known as “solar grade silicon” is the most prevalent bulk material for solar panels with an average efficiency of 15%. A commercial solar panel of crystalline silicon “C—Si” model “LG265 Si—C 265G3” product line of “Monox”, with dimension of 65″×40″×1.4″, and efficiency of 16.4% with the following specification has been selected.

### Selected Solar Pane Specification:

| Model Number | LG265 Si—C 265 G3 | |
|---|---|---|
| Product Line | Monox | |
| Dimensions (inches) | 64.57″ × 39.37″ × 1.38″ | |
| Dimensions (metric) | 165 cn × 100 Cn × 3.5 Cn | |
| Light Capture Area: Ft² (M²) | 18 Ft² (1.65 M²) | |
| Max. System voltage | 600 | volts |
| System power rating (watts) | 265 | watts |
| Watt (PTC) | 239.5 | watts |
| Max Power voltage | 31.4 | volts |
| Max Power current | 8.46 | amps |
| Open Circuit voltage (V_{oc}) | 38.7 | volts |
| Short circuit current (I_{sc}) | 8.92 | amps |
| I_{sc} × V_{oc} | 345.2 | VA |
| Power rated/I_{sc} × V_{oc} | 76.8% | |
| Watt (PTC)/I_{sc} × V_{oc} | 69.4% | |
| Series Fuse rating | 15 | amps |
| Panel Efficiency | 16.2% | |
| Watt/Ft² | 14.72 | w/Ft² |
| Price $/Panel | | |

| | |
|---|---|
| (E-bay average of 27 to 162 panels) | $310/panel |
| Price/Ft² ($/Ft²) | $17.22/Ft2 |
| Price/M² | $188/M² |
| Price/Watt | $1.17/watt |

### Solar Panel Frame 208:

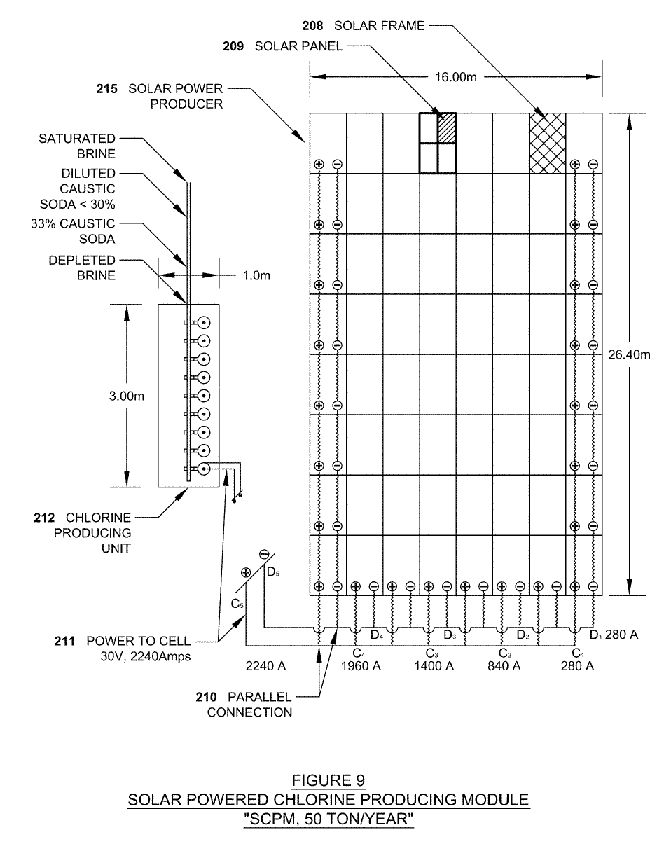

For construction purposes, it is feasible to select a “solar frame” as a unit power generator to power the electrolysis cells. This frame should have a dimension easy to build, transport, installed, and have enough irradiant capture area. The frame is made from four (4) panels of “LG 265 Si C” and has dimension of 3.3 m×2.0 m with area of 6.6 m². FIG. 9 shows solar frame 208, which is made from four (4) solar panels 209.

### Frame's Energy Production:

The frame energy production when installed in California or Florida (with annual average of 1000 w/m²) and with efficiency of 16.4% will be:

Pm=16/4%×1000 w/m2×6.6 m²=1082 w (frame power point)

Annual Frame's production is:

KWH/year=(365 days)×(five hrs./day)×1.082 kW=1975 KWH/yr.

Frame's Life production is:

KWH/yr.×25 yrs.=49,366 KWH/lifetime

### Solar Frame's Cost:

The cost of each frame made of four (4) panels LG 265 Si C will be:

4 panel×$310/panel+$260.holding frame=$1500/frame

### Frame's Voltage and Current:

All four (4) panels each with power voltage of 31.2 v and current of 8.46 amps electrically connected in parallel. Therefore, the frame voltage is 31.2 volts and frame current is near 35 amps.

### Frame's Energy in Column “C”:

Frame energy production in Column C is dependent on operating voltage of chlorine producing cells.

In membrane cell (selected for this invention), the operating voltage is 3 to 3.6 volts with average of 3.3 volts.

Frame's energy in column for one (1) year and lifetime is given per the following equations:

I=W_{watts}/Vᵥₒₗₜₛ=Aₐₘₚₛ

I=1082 w/3.3 v=327.9 Amps

C_{column}=I_{Amps}×t_{second}

C/Frame annual=(327.9 Amps)×(365 day/yr.)×(5 hrs./day)×(3600 sec/hr.)

C/Frame annual=2.154×10⁹ column/year

C/Frame 25 year=5.386×10¹⁰ column/25 yeas.

F/Frame year=2.23/10⁴ Farad/year

F/Frame 25 years=5.582×10⁵ Farad/25 year

### Frame's Annual Theoretical Production:

In theory, one farad of electric energy in electrolysis of one molecule gram of table salt solution will produce the following elements:
1. Chlorine gas: one atom gram of gas that is 35.5 grams
2. Hydrogen: one atom gram hydrogen, that is 1.01 grams
3. Sodium: one atom gram Na, that is 23 grams or 40 grams of 100% causticsoda.
   Production can be calculated as:

$$\\ \begin{matrix}1. {Frame}^{′} s {Cl}_{2} \text{/} year = ( 2.23 \times {10}^{4} F ) \times ( 35.5 Gr / {10}^{6} Gr \text{/} ton ) \\ = 0.791 ton \text{/} yr .\end{matrix}$$

$$\begin{matrix}2. {Frame}^{′} s Na OH \text{/} yr . = ( 2.23 \times {10}^{4} F ) \times ( 40 Gr / {10}^{6} Gr \text{/} ton ) \\ = 0.892 ton \text{/} yr .\end{matrix}$$

$$\begin{matrix}3. {Frame}^{′} s {H}^{2} \text{/} yr . = ( 2.23 \times {10}^{4} F ) \times ( 1.01 Gr / {10}^{6} \text{/} ton ) \\ = 0.225 ton \text{/} yr .\end{matrix}$$

### C—DETAILED DESCRIPTION OF INVENTION

The Invention is Solar Powered Chlorine Producing Module for 50 tons of chlorine per year, called “SCPM”.

“SCPM” has two main parts:

A—Solar panel assembly that provides power called “solar power producer”
B— Chlorine Producing Unit called “Cl₂ Unit”

### A—Solar Power Producer 215:

FIG. 9 depicts a “SCPM” (Solar Powered Chlorine Producing Module) with 50 ton Cl₂ per year.

The power source of this module is the assembly 215 that is made of 64 solar frames 208, and arranged in eight columns. Each column has eight (8) solar frames 208. The solar frame 208 are made from four (4) commercially silicon solar panels of 209. The solar panel is model “LG265 Si.C 265G3” product line of “Monox” that its specification is already given in the solar section. All sixty-four (64) solar frame are electrically connected in parallel according to wiring 210, and the final power feeder 211 to “Cl₂ unit 212” will have voltage of 31 volts and the current of 2233 amps.

Feeder 211 of FIG. 9 could be a single copper bus strap start from the right-hand side to the left side with the following dimensions:
1. Section C1C2 and D1D2 will have a cross-section of ⅜″×2¼″ (10^{m}/m×54^{m}/m) or 1×800 MCM, THHN wire carrying 558 amps
2. Section C2C3 and D2D3 will have a cross-section of ⅜″×5.5″ (10^{m}/m×75^{m}/m) or 2×800 MCM, THNN wire carrying 1116 amps
3. Section C3C4 and D3D4 will have a cross-section of ¾×3½″ (20^{m}/m×80^{m}/m) or 3×800 MCM, THNN wire carrying 1675 amps
4. Finally, Section C4C5 and D4D5 and throughout of “Cl₂ unit” will have a cross-section of ¾×4½″ (20^{m}/m×110^{m}/m) or 4×800 MCM, THNN wire carrying 2233 amps

“Cl₂ Unit 212” Electrical Connection 211:

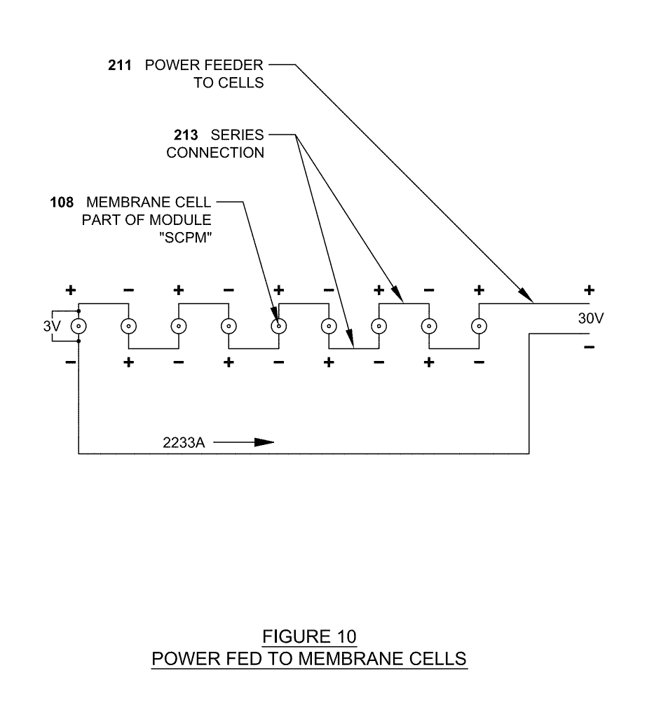

FIG. 10 depicts the power supply 211 to “Cl₂ unit 212”. The “Cl₂ unit 212”. Has nine (9) membrane cells 214, each operating with 3.3 volts and 2233 amps. Membrane cells are electrically connected in series connection 213.

### Specification of Solar Power Assembly 215:

| Solar Irradiance | 1000 | Watts/m2 |
|---|---|---|
| Solar Panel 209 model | LG 265 SIC 265 G3″ | |
| Manufacturer | Monox | |
| Solar Panel 209, dimension | 165 Cn × 100 Cn × 3.5 Cn | |
| Solar Frame 208 dimension | 330 Cn × 200 Cn × 3.5 Cn | |
| No. of Panel 209 in frame 208 | 2 × 2 panels (4 panels) | |
| Frame 208 Pmax | 1082 | watts |
| Frame 208 V_{Max} | 31.4 | volts |
| Frame 208 I_{SC Max} | 34.9 | amps |
| No. of Frame 208 in solar assembly | 64 | frames |
| Solar power 215 operating voltage | 31 | volts |
| Solar power 215 operating current | 2233 | amps |
| Solar power 215 capture area | 422 | M² |

### B—Chlorine Producing Unit “Cl₂ Unit” 212

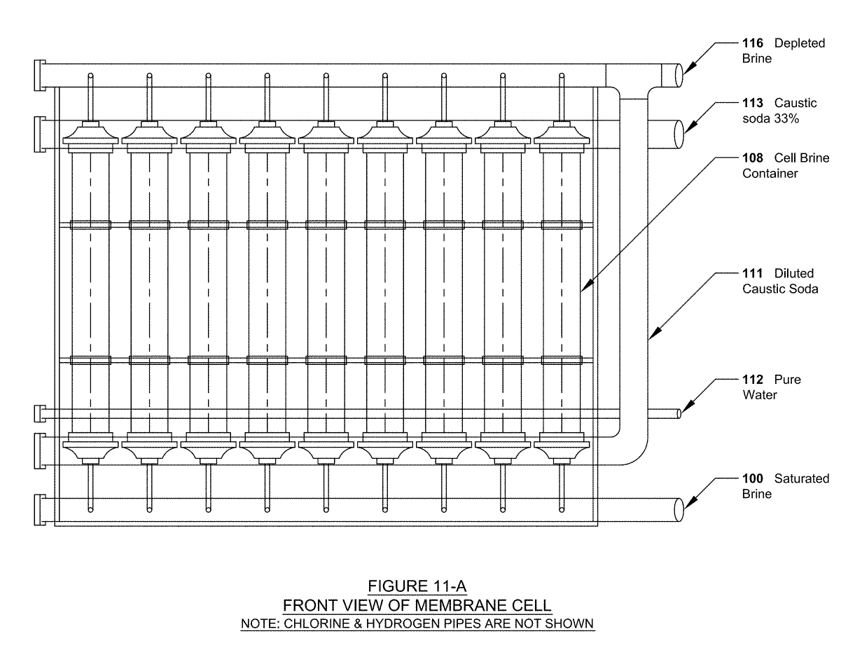

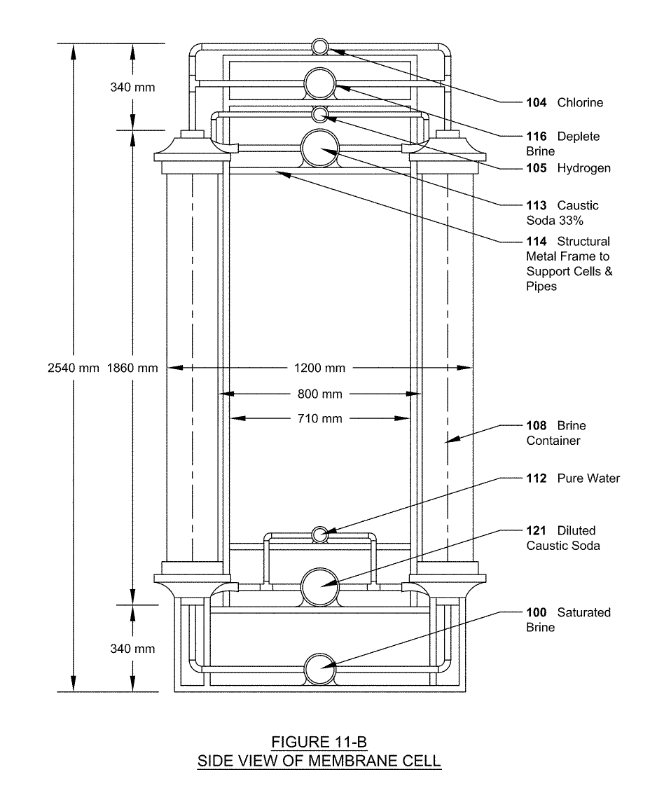

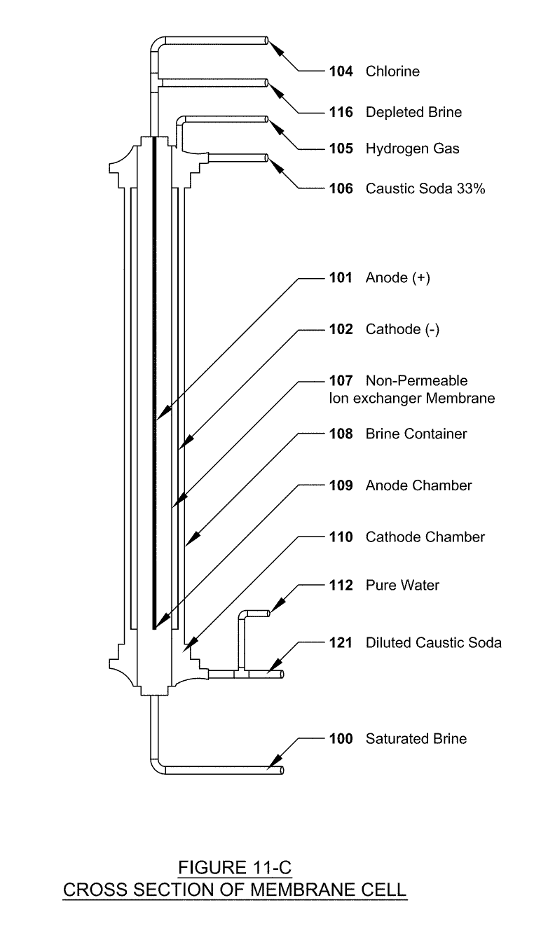

FIGS. 11-A, 11-B and 11-C depict frontal view, side view, and cross-sectional view of new membrane chlorine producing Unit 212 in FIG. 9, that will be used in this invention. FIG. 11-A depicts the arrangement of a row of nine (9) cells 108, piping connection of entering saturated Brine 100 and leaving depleted Brine 116, diluted Caustic 121 and 33% Caustic 113 leaving the Unit. FIG. 11-B depicts the structural Frame 114 to support the two rows of membrane Cells 108, saturated Brine 100 and its branches to Cells 108, diluted Caustic 121, and pure Water 112 and its branches to diluted Caustic 121. FIG. 11-C depicts the cross-section of one cell with its related piping. Brine Container 108 is a PVC slim cylinder, a non-permeable ion-exchanger Membrane 107 divided the Container 108 into Anode Chamber 109 and Cathode Chamber 110. Saturated Brine 100 enters Anode Chamber 109 and depleted Brine 116 leaves the Anode Chamber 109 at the top. Pure Water 112, along with diluted Caustic 121, enters at the bottom of Cathode Chamber 110 and 33% Caustic Soda 113 leaves Cathode Chamber 110 at the top. Chlorine Gas 104 leaves the Anode Chamber 109 at the top, and Hydrogen Gas 105 leaves at the top of Cathode Chamber 110.

### Anode 101:

Up to 1970 electrolytic cell, anodes were graphite. New anodes are Titanium (Ti) metal electro-coated with an Oxide of Platinum group family (Ruthenium, Titanium, Tin and zirconium). Titanium anode Electro-Coated with Ruthenium Oxide (RUO₂) and Titanium oxide (TiO₂) are high current density in low voltage. The use of RUO₂ and TiO₂ coated Titanium Anodes reduces energy consumption by about 10% and higher life expectancy. Competitive design of anode geometry is today's industry challenge, all with the aim of improving gas release, to reduce Ohmic resistance losses and increase the anode life by improving the homogeneity of the brine.

### Life of Anode:

Metal Anode lives are 12, 8 and 4 years for diaphragm, membrane, and mercury, respectively. In mercury cell, short circuit between anode and cathode cause the wear of anode coating.

### Cathode 102:

Is nickel often coated to reduce energy consumption? Reducing the distance between Anode 101 and Cathode 102 will reduce the ohmic resistance and Will reduces the operating voltage and energy. This is the reason behind the new slim cylinder cells.

Recently, a new oxygen depolarized cathode (ODC) has been used. Oxygen is pumped into the cell to react with liberated hydrogen in Cathode to form water, results in lower cell resistance, and lower the voltage needed for the electrolysis process. This voltage reduction could be as low as 50%. A disadvantage of this process is that the hydrogen is no longer available as an important and valuable product.

### Membrane 107:

Membrane 107 with thickness 0.15 to 0.3 mm is co-polymer of tetra-fluoroethylene (C₂.F₄) Groups, and is non-permeable, but ion exchanger membrane.

### Maintenance and Operation:

To reduce the maintenance cost of cell operation, the following precautions should be considered:
1—Organic acids, Fluorides and Manganese cause damage to anode's Coating.
2—Operation in alkaline brine with PH bigger than eleven (PH>11) will cause a rapid destruction of the Anode's coating
3—Operation with low concentrated and cold brine led to production of Sodium Hippo Chloride (Cl O Na) that should be avoided.

### Membrane Cell Consumption and Productions:

The following numbers are the, products, material and energy used, as base, to produce one metric ton (1000 kg) of chlorine gas:
a—One metric ton of chlorine gas.
b—Other Products;
   b₁—1.128 tons of 100% Na OH (Sodium hydroxide).
or b₂—Alternatively, 1.577 tons of 100% KOH (Potassium hydroxide).
   c—By product of 28 Kg hydrogen.
d—Raw material;
   d₁—1.66 tons of pure table salt (Cl Na).
or d₂—2.1 to 2.2 tons of potassium chloride (Cl K).
e—Energy used;
   e₁—To-day's Membrane Cells use 2,500 KWH per one metric ton of chlorine.
   e₂—Extra 500 KWH will used to concentrate the caustic soda to 50%.

### Product's Purification and Concentration:

### Chlorine Purification;

Chlorine produced by all cells has some water vapor. Concentrated sulfuric acid (92% to 98% of So₄H2) is used to dry chlorine. If re-concentration takes place at site, also a small amount of the sulfuric acid per ton of chlorine will be used for elimination of (Cl—O—Na) and PH control.

Caustic soda produced by cells has some Cl Na, by boiling the product; excess salt will be crystallized and separate from caustic soda.

### Caustic Soda Concentration;

Indirect heating with steam will do caustic soda concentration, and sulfuric acid concentration.

### Specification of Designed “Cl₂ Unit 212”

| | | |
|---|---|---|
| 1 - Unit capacity | 50 | ton/year |

| | |
|---|---|
| 2 - Number of membrane cells | nine cells |
| 3 - Power supply: | solar |

a - Operating Voltage Vₒₚ

| | | |
|---|---|---|
| a-1 -V_{op Max} (Noon time) | 34 | volts |
| a-2 -V_{opMin} (Morning & Afternoon) | 3.4 | volts |

b - Operating current Iₒₚ

| | | |
|---|---|---|
| b-1- I_{op Max} (Noon time) | 2233 | AMPS |
| b-2 - _{Iop Min} (Morning & Afternoon) | 700 | AMPS |

4 - Membrane:

| a - current density “design” KA/Ft² | 450 | AMPs/Ft² |
|---|---|---|
| | 4.84 | Kamp's/M² |
| b - Area/cell | 5 | Ft²/cell |
| c - Membrane Diameter | 4 | inches |
| d - Membrane length | 60 | inches |
| e - Membrane Area/cell “actual” | 5.23 | Ft²/cell |
| f - Current Density “actual” | 426.7 | AMPS/Ft² |

| | |
|---|---|
| 4.59 | Kamp's/M² |

| | |
|---|---|
| g - “Cl₂ Unit” total area (9 × 5.23 M²) | 47 Ft² (4.37 M²) |

5 - Production per year:

| | | |
|---|---|---|
| a - Chlorine gas (metric ton = 1000 Kg) | 50 | ton/year |
| b - Caustic Soda | | |

| | | |
|---|---|---|
| 100% | 56.4 | ton/year |
| 50% | 112.8 | ton/year |

| | | |
|---|---|---|
| c - Hydrogen | 1.4 | ton/year |

### Case Study:

This invention was applied in design of chlorine producing plant for a municipality with a population of 170,000.

In this design, the production capacity could be increased throughout the life of the plant if chlorine demand increases. In the 25-year life of the plant, there will be four times capacity expansion at the start of the 2^{nd}, 3^{rd}, 4^{th} and 5^{th} period of five years period with addition of 3, 3, 4, and 3 “SCPM, 50 ton/yr.” to the plant. Due to this expansion, the increase of Cl₂ production takes place in four (4) steps, while the city demand is exponential; that results in excess Cl₂ production.

The excess chlorine will be sold to other cities at 80% of the buying price of offsite Chlorine by city, as an income to the city.

The city's caustic soda consumption is about 33% of the plant production. The 67% excess product of the plant will be sold to other cities at 75% of the buying price of offsite caustic soda by city, as an income to the city.

The plant hydrogen by-product may be sold at the price of 75% of the market price as income to the city.

If, instead of selling the hydrogen, it is converted to ammonia (NH₃), it will provide 56.5% of City's consumption, and the city needs to buy only 43.5% of its consumption.

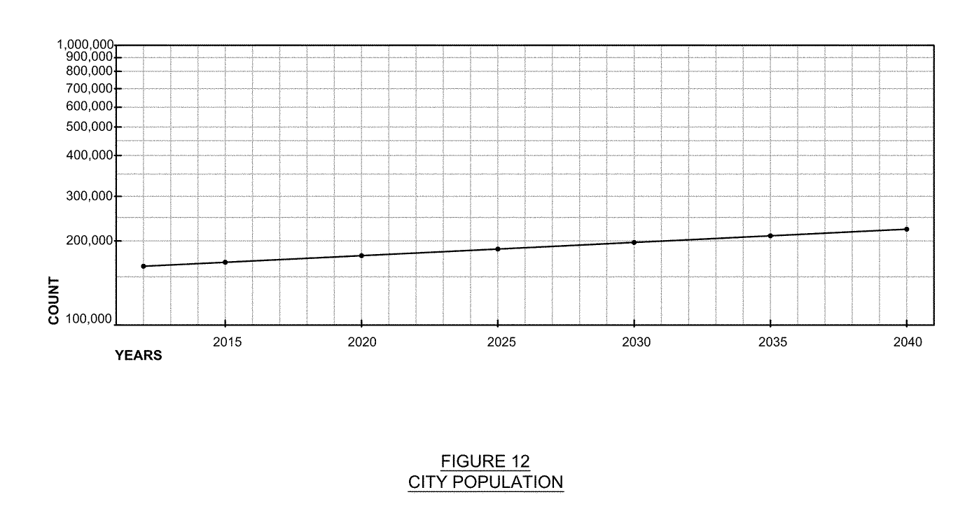

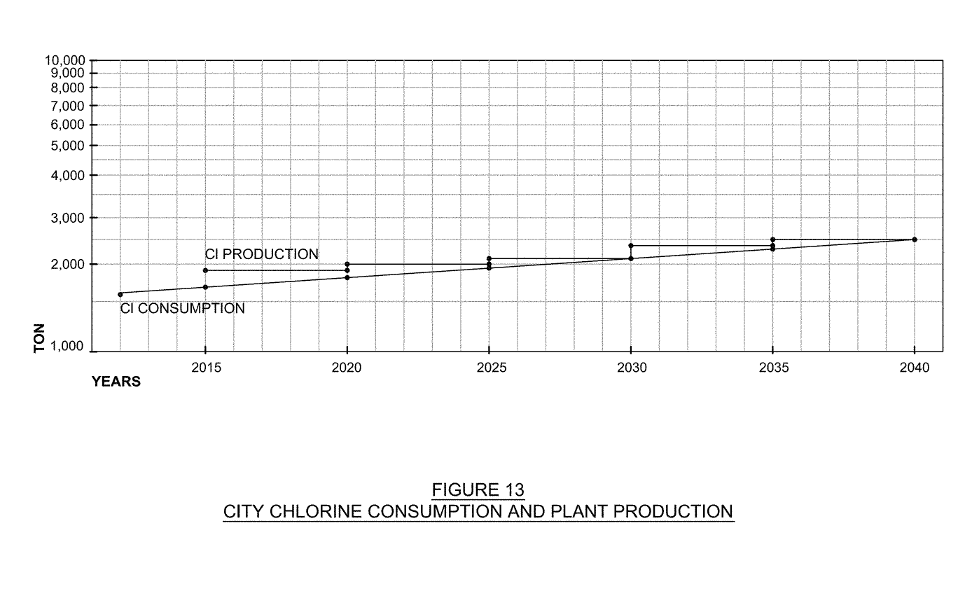

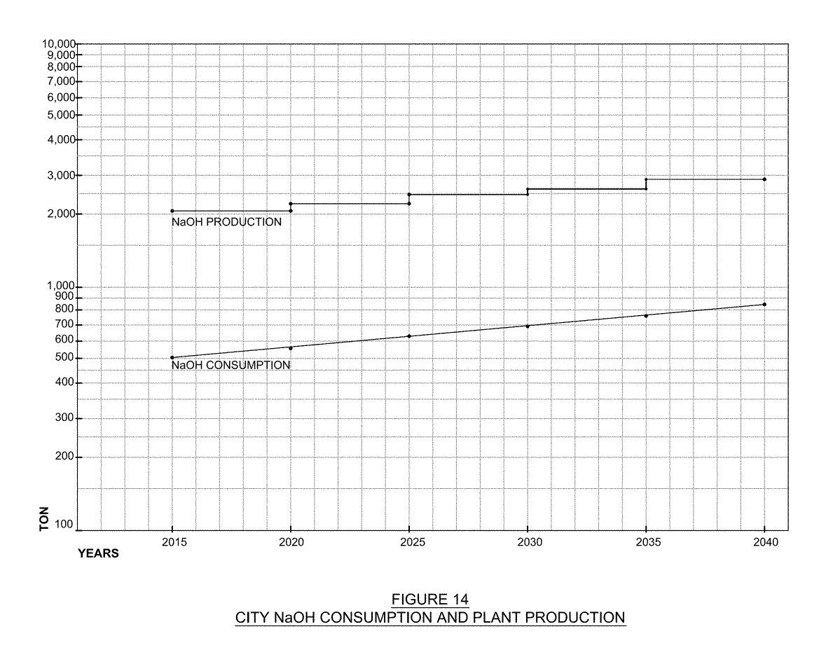

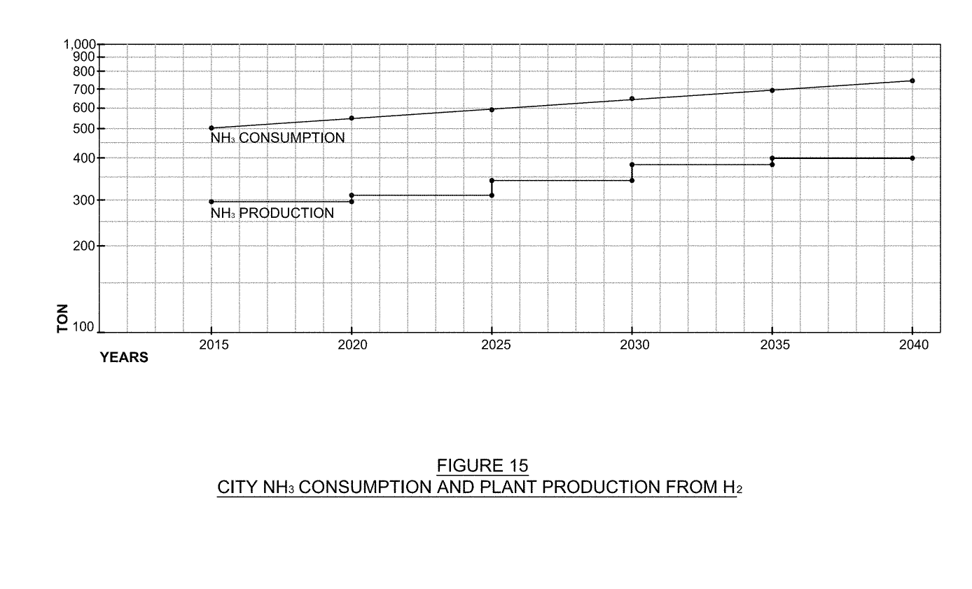

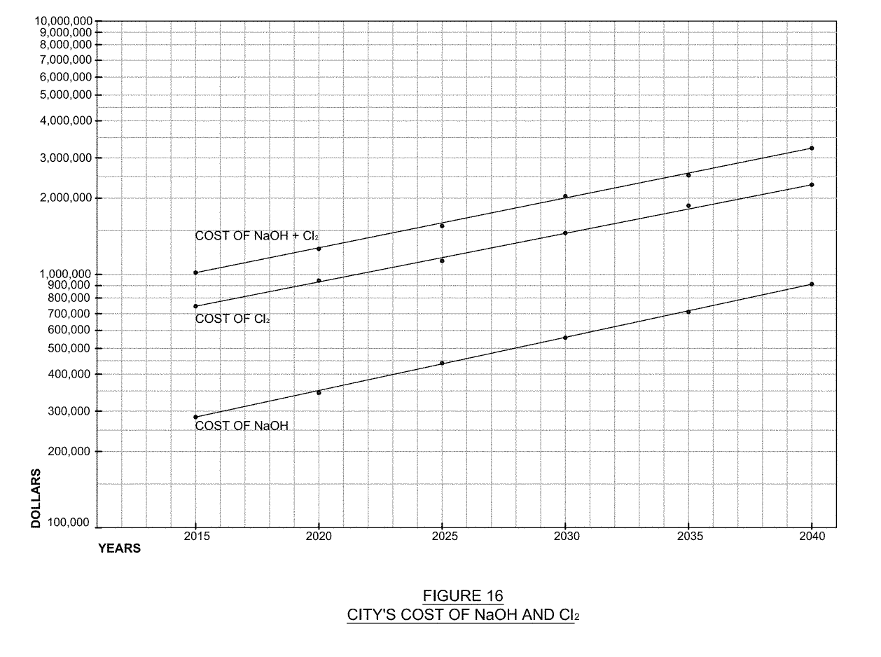

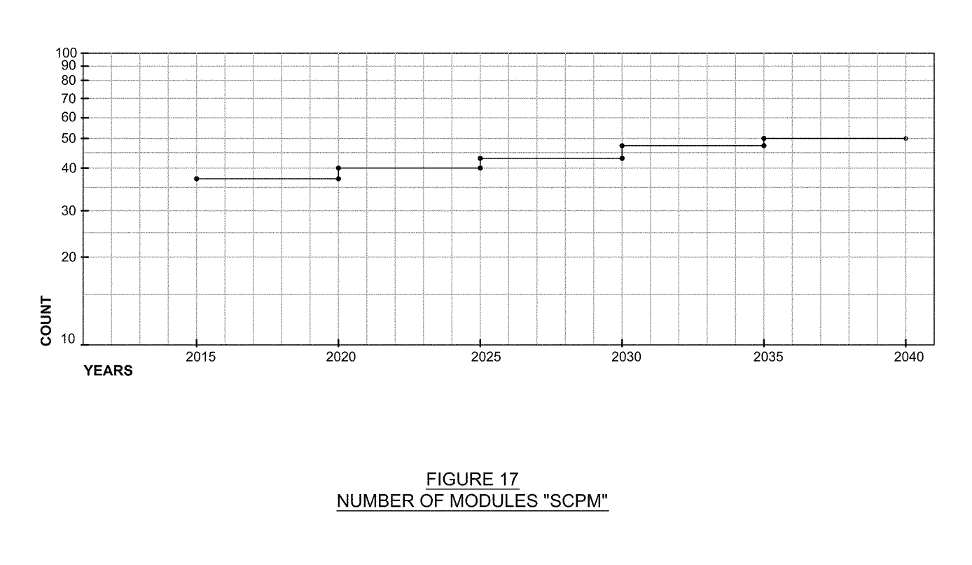

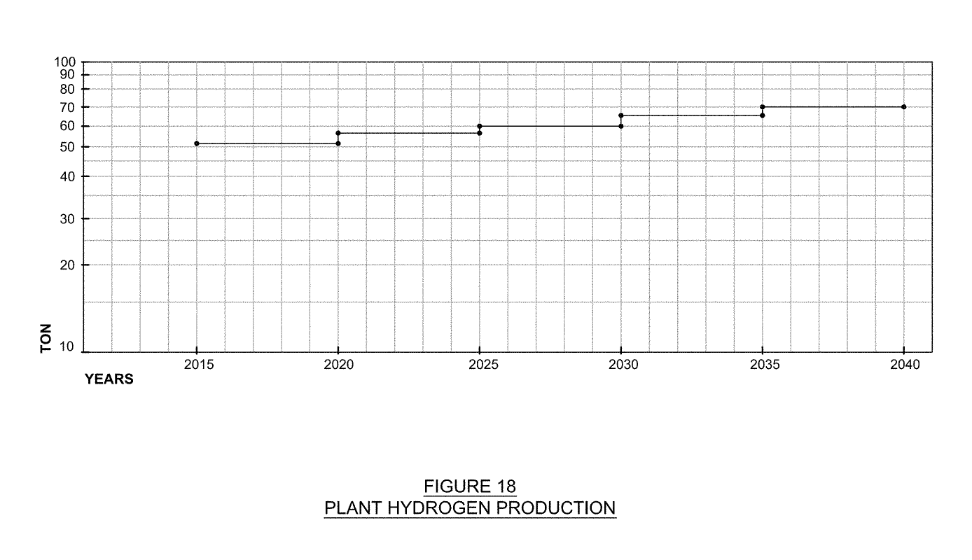

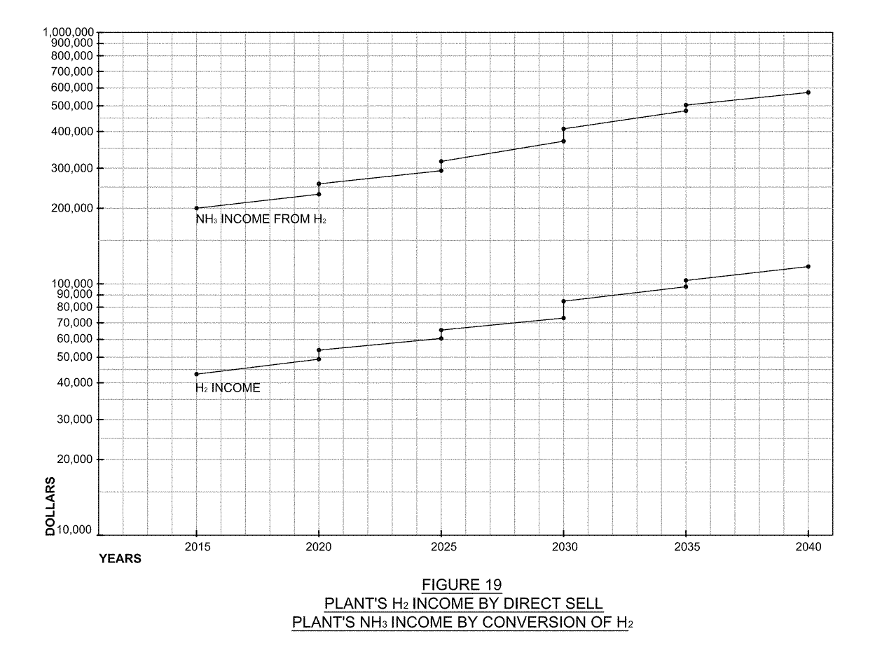

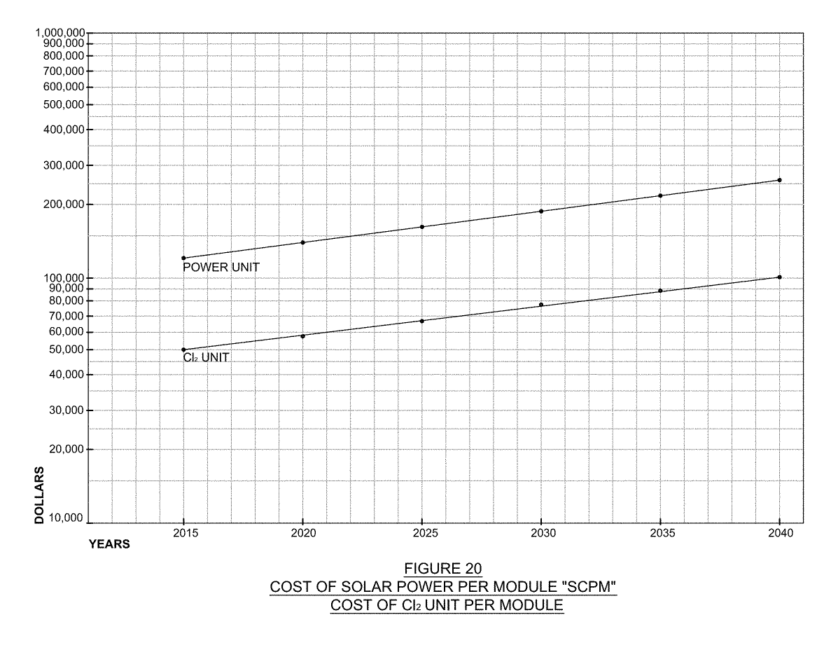

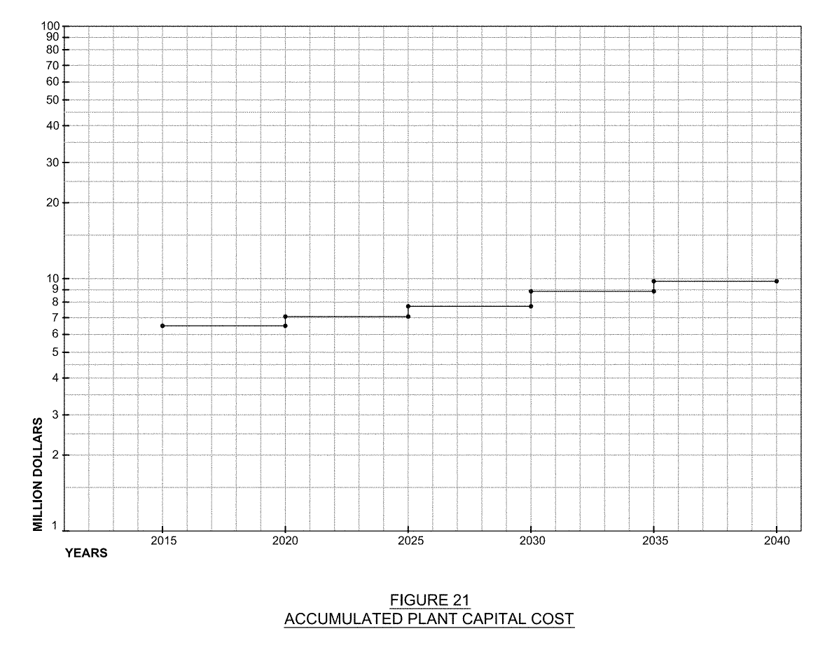

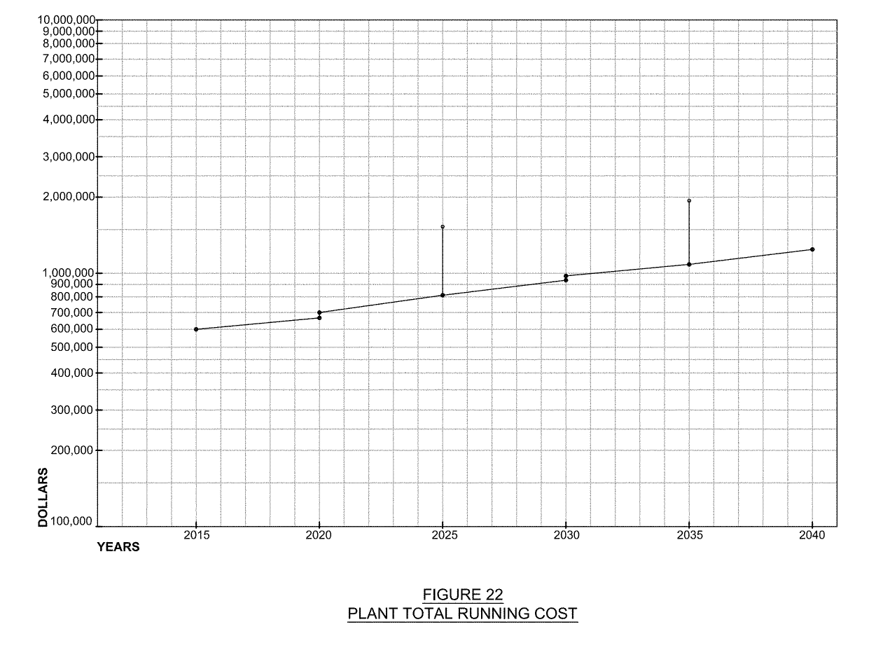

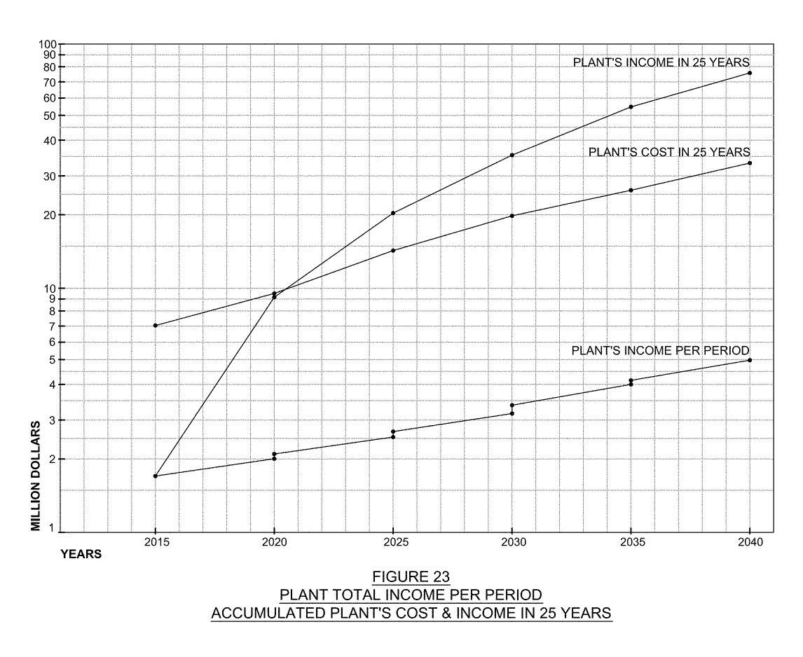

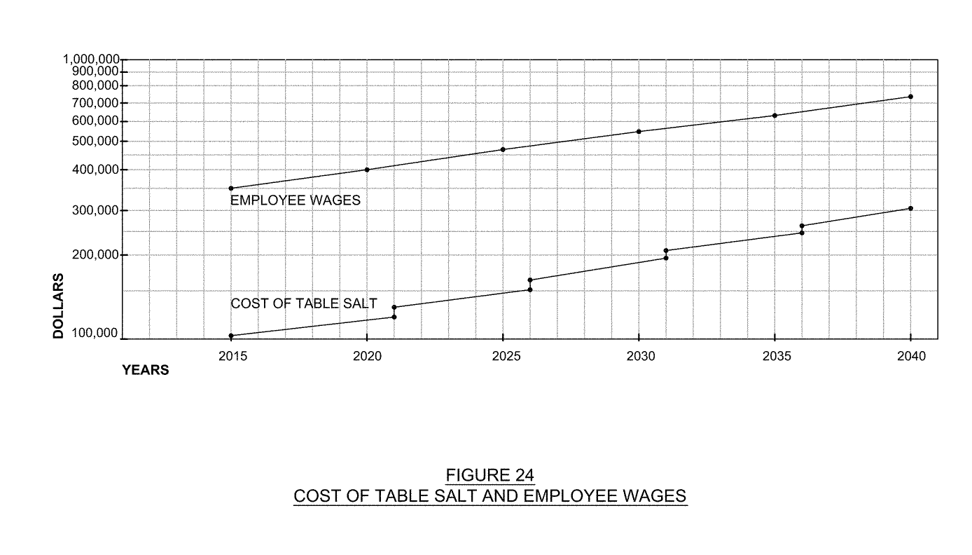

The summary of this case study has been given in the following graphs.
FIG. 12—depicts the City's population from 2008 to 2040 according to the U.S. Census Bureau
FIG. 13—depicts the City's chlorine (2015-2040):
   a. Annual chlorine consumption
   b. Annual suggested plant production
FIG. 14—depicts the City's caustic soda (2015-2040):
   a. Annual caustic soda (Na OH) consumption
   b. Annual suggested plant production
FIG. 15—depicts the City's ammonia (2015-2040):
   a, Annual ammonia “NH₃” consumption.
   b, Annual ammonia “NH₃” production
FIG. 16—depicts: The city's cost for chlorine and caustic (2015-2040):
   a. Annual cost of chlorine consumed
   b. Annual cost of caustic soda consumed
   c. Total City's annual cost of Cl₂ plus caustic soda.
FIG. 17—depicts the initial required number of “SCPM” modules in the plant, and the number of “SCPM” modules in the plant's expansion to meet the City's chlorine demand.
FIG. 18—depicts the City's hydrogen (H₂) product as the plant's by-Product.
FIG. 19—depicts:
   a. City's income by selling hydrogen at 75% of market price.
   b. City's income if all hydrogen converted to ammonia (NH₃) as supply near of 57% of City's ammonia consumption.
FIG. 20—depicts:
   a. The cost of solar power 215 per module “SCPM”, FIG. 9.
   b. The cost of “Cl₂ unit 212” per module “SCPM”, FIG. 9.
FIG. 21—depicts:
   Accumulated plant capital cost in 25 years period.
FIG. 22—depicts the plant's total running cost in 25 years.
FIG. 23—depicts
   a, Employees wage to operate the plan through its life span of 25 years.
   b, the cost of annual Table Salt consumed as raw material for 25 years plant's life span.
FIG. 24 depicts—
   a, plant's total income per 5-years period.
   b, Accumulated plants total cost in 25 years.
   c, Accumulated plants total income in 25 years.
At year 2040 (the end of plant's life)
   the total accumulated income in 25 years is about $76,300,000.
   the total accumulated cost including capital investment and running cost (Running energy+Maintenance+Replacement) in 25 years is About $33,560,000.
   The plant's net income in 25 years is $42,740,000.

### BRIEF DESCRIPTION OF DRAWINGS

To explain and better understanding of drawings, assigned numbers has identified the products, elements of solar power producing unit, chlorine producing cell assembly, and related accessories. The assigned numbers used in figures are given in the following table.

### DESCRIPTION OF ASSIGNED NUMBERS

| | | ASSIGNED |
|---|---|---|
| ITEM | DESCRIPTION | NUMBERS |
| 1 | Electrolyte Solution: | 100 |
| | Acid + Water/Salt + Water | |
| 2 | Anode | 101 |
| 3 | Cathode | 102 |
| 4 | DC Power Source | 103 |
| 5 | Anion (Non-metallic elements) | 104 |
| | Cl₂, O₂ | |
| 6 | Cation (Metallic elements) Na, Fe, H | 105 |
| 7 | Caustic Soda under 30% | 106 |
| 8 | Diaphragm or Membrane | 107 |
| 9 | Cell Container | 108 |
| 10 | Anode Chamber | 109 |
| 11 | Cathode Chamber | 110 |
| 12 | Diluted Brine | 111 |
| 13 | Pure Water | 112 |
| 14 | Caustic Soda 33% | 113 |
| 15 | Structural Frame | 114 |
| 16 | Brine Concentrator | 115 |
| 17 | Depleted Brine | 116 |
| 18 | Decomposer | 117 |
| 19 | Amalgam (Na Hg) | 118 |
| 20 | Recycled Mercury | 119 |
| 21 | Caustic Filter | 120 |
| 22 | Diluted Caustic Soda | 121 |
| 23 | Solar Panel at 32° | 200 |
| 24 | Solar Panel at Noon | 201 |
| 25 | Solar Panel at 6:00 a.m. & 6:00 p.m. | 202 |
| 26 | Sun at 6:00 a.m. & 6:00 p.m. | 203 |
| 27 | Sun at Noon | 204 |
| 28 | Sunlight at Noon | 205 |
| 29 | Sunlight at 6:00 a.m. & 6:00 p.m. | 206 |
| 30 | Horizon | 207 |
| 31 | Solar Frame | 208 |
| 32 | Solar Panel | 209 |
| 33 | Parallel Connection | 210 |
| 34 | Power to Cl₂ Producing Unit | 211 |
| 35 | Cl₂ Producing Assembly Unit | 212 |
| 36 | Series Connection | 213 |
| 37 | “SCPM” Membrane Cl₂ Cell | 214 |
| 38 | Solar Power Producing Unit Assembly | 215 |

FIG. 1 shows the basic set-up in the laboratory. It explains electrolysis of water with hydrochloric water 100 or solution of Table Salt 100 into their elements. Water 100 breaks down into Oxygen 104 in Anode 101 and Hydrogen 105 in Cathode 102. Table sale Solution 100 breaks down into Chlorine 104 in Anode 101 and Na OH 106 in Cathode 102.

FIG. 2 explains the concept of diaphragm cell for producing chlorine from saturated table salt solution. Diaphragm 107 divides Container 108 into two sections of Anode Chamber 109 and Cathode Chamber 110. Saturated Brine 100 enters Anode Chamber 109 at the top. Chlorine ions will be attracted to anode 101, give up one electron, and become chlorine Gas 104 that accumulates at the top of Anode Chamber 109. Sodium ions pass through Diaphragm 107 and enter Cathode Chamber 110. Some interact with Hydroxide Ions (OH⁻¹) from Cathode 102 to form Caustic Soda 106, while some attract to Cathode 102, receive one electron and convert to metallic sodium. Metallic sodium reacts with water to produce Caustic Soda 106 and Hydrogen 105 which accumulates at the top of Cathode Chamber 110.

FIG. 3, is a view of commercial diaphragm cell. In this Figure, Brine 100, Anode 101, Cathode 102, Power 103, Chlorine Gas 104, Hydrogen Gas 105, diluted Caustic Soda 106, Diaphragm 107, Container 108, Anode Chamber 109, Cathode Chamber 110, Diluted Brine 111, and 30% Caustic Soda 113 are given. Diluted Brine 111 passes through diaphragm 107 into Cathode Chamber 110.

FIG. 4, is a simplified view of a membrane chlorine producing cell. A non-permeable and ion-exchanger membrane 107 divides the Container 108 into two Anodes, Chamber 109 and Cathode Chamber 110. Saturated Brine 100 enters from the bottom to Anode Chamber 109 and as depleted brine 116 leaves the Chamber 109 at the top. Caustic Soda 106 and Water 112 enter the Cathode Chamber 110 at the bottom and as it moves up, it picks Caustic Soda generated in Cathode 102. Rich Caustic Soda 113 with 30% to 33% density leaves at the top. Chlorine Gas 104 accumulates at the top of Anode 101 and Hydrogen Gas 105 collects at the top of Cathode 102.

FIG. 5, shows a view of commercial chlorine membrane cell. All elements in this drawing is the same as FIG. 4 except that the brine circuit from saturated 100% entering the Anode Chamber 109, loses its chlorine ions to Anode and becomes depleted Brine 116 that enters into concentrator 115, becomes saturated Brine 100 and repeats the cycle. Caustic Soda 33% of 113 enters to caustic container and leaves the cell. Caustic soda 106 as Part of Caustic Soda 113 becomes diluted with Water 112, enters to Cathode Chamber 110, receives caustic from Cathode 102 and becomes 33% Caustic 113. Ions of Na⁺¹ Enter Cathode Chamber 110, some interact with Hydroxide ions (OH⁻¹) from Cathode 102 to from Caustic Soda 106, and some attract to Cathode 102, receive one electron and convert to metallic Sodium. Metallic Sodium reacts with water to produce caustic soda 106 and Hydrogen 105, which accumulates at the top of Cathode Chamber 110.

FIG. 6, shows a simplified view of Chlorine Mercury Cell. A mercury film over an inclined flat surface acts as Cathode 102. Anode 101 is metal plates parallel to mercury surface and in close distance. Saturated Brine 100 enters the Container 108 from the top. It gives away its chlorine ions to Anodes 101 that become Chlorine Gas 104. Its sodium ions go to mercury Cathode 102 and by receiving one electron become Metallic Sodium. Sodium reacts with mercury and forms Amalgam (Na—Hg 118) that leaves Cathode 102. After all this process, saturated Brine 100 becomes depleted Brine 116 that leaves the cell at the top. Amalgam (Na—Hg 118) in Decomposer 117 reacts with Water 112, breaks down into Caustic Soda 50% 113 and Hydrogen 105 and recycled Mercury 119. Hydrogen 105 will be collected at the top of the Decomposer 117 and Mercury 119 will be pumped to Cathode 102.

FIG. 7, Shows a view of commercial mercury chlorine cell. All elements and process are identical to FIG. 6.

FIG. 8, Shows a rotating solar Panel 200. Panel orientation at Noon 201 has a tilted angle of 42°, and panel Position 202 has better efficiency at early morning and afternoon. The sun's location is given at Noon 204 and for early morning and late Afternoon 203, having angles of 42° and 32° respectively with horizon 207

FIG. 9, Shows Solar Power Producer 215, part of invention of “SCPM” (Solar Powered Chlorine Producing Module). Solar power Producer 215 is made of eight columns and each column has eight Frames (208), with the sixty-four (64) frames. Each Frame 208 has four solar panels of 209. In this assembly, all panels are connected electrically in Parallel 210 and the power to chlorine cells 211 has 30 v and 2233 amps.

FIG. 10, Shows Membrane Cells 214 is electrically connected in Series 213. Power feeds to Assembly 211 has 30 v and 2233 amps.

FIG. 11-A, Shows front view of “SCPM”-“Chlorine Producing Cell” assembly and its associated piping. The Assembly has nine (9) membranes Cells 108. The cell's detail is given in FIG. 11(c). Saturated Brine 100 enters Anode Chamber 109 cells from the bottom strip off its ions, moves up and leaves the cell as depleted Brine 116. Diluted Caustic Soda 121 mixes with pure Water 112 and enters at the bottom of Cathode Chamber 110. As it moves up, it receives Caustic Soda (Na OH) from Cathode 102, becomes rich Caustic 113 with 33% that leaves the Assembly at the top.

FIG. 11-B, Shows the side view of “SCPM”-Solar Chlorine Producing Module. The view shows two membrane Cells 108 and associated piping. The main saturated Brine 100 and its branch feed to each cell located at the bottom. Diluted Caustic Soda 121 and pure Water 112 and their associated piping are located at the bottom of the cell. Structural metal Frame 114 supports cells and associated pipes. Caustic Soda 33% collector Pipe 113 and its branches to cell's cathode chamber are located at the top. Hydrogen collector Pipe 105 and its branches to cathode chamber are located at the top of the cell. Depleted brine collector pipe 116 and chlorine collector Pipe 104 and their branches to cell's anode camber are located at the top of the Assembly.

FIG. 11-C: Shows the cross section of membrane cell. Brine Container 108 is divided by cylindrical non-permeable and ion exchanger Membrane 107 into Anode Chamber 109 and Cathode Chamber 110. Saturated Brine 100 enters Anode Chamber 109 at the bottom, gives up its ions as it moves up and becomes depleted Brine 116 that leaves the cell a t the top. Chlorine Gas 104 releases from Anode 101, will be collected at the top of Anode Chamber 109, and leaves the cell. Diluted Caustic 121 mixes with pure Water 112 and enters Cathode Chamber 110 at the bottom. As it moves, up, it absorbs caustic soda from Cathode 102 and becomes Caustic Soda 113 with 33% that leaves the cell at the top. Hydrogen Gas 105 that release from Cathode 102 will be collected at the top of Cathode Chamber 110 and leaves the cell.

### Case Study's Figures

FIG. 12, The City's population from Year 2000 to Year 2040

FIG. 13, The City's chlorine consumption (2000-2040) and chlorine produced by “SCPM” Plant from Year 2015 to 2040

FIG. 14, The City's caustic soda (Na OH) consumption and caustic soda produced by “SCPM” plant from year 2015 to 2040

FIG. 15, The City's ammonia (NH₃) consumption and “SCPM” ammonia production from Year 2015 to 2040.

FIG. 16, The City's cost for used chlorine (Cl₂) and caustic soda (Na OH) and their total from year 2015 to 2040

FIG. 17, The City's plant required number of “SCPM” (module with 50-ton chlorine Production per year) from Year 2015 to 2040.

FIG. 18, The City's hydrogen production, by city chlorine plant from Year 2015 to 2040.

FIG. 19, The City's income if hydrogen is marketed directly, or converted to ammonia From Year 2015 to 2040.

FIG. 20, The cost of one solar power assembly 215, (FIG. 9) and one chlorine cell assembly 212, (FIG. 9) of one “SCPM” from Year 2015 to 2040.

FIG. 21, The City's initial capital cost in Year 2015 and additional capital cost for the Plant's capacity increase for four periods of five years, from 2015 to 2040.

FIG. 22, The Plant's total running cost from Year 2015 to 2040, and two major chlorine cells replacement in Years 2025 and 2035.

FIG. 23, The City's chlorine plant cost of raw material and labor,
a—the plant's cost of employees that run the plant from Year 2015 to 2040.
b—the plant's cost of used table salt from Year 2015 to 2040.

FIG. 24, Shows the, capital cost, running cost, and income from 2015 to 2040.
a—plant's total gross income per five-year period for 2015 to 2040
b—plant's accumulated cost (capital and running cost) from Year 2015 to 2040.
c—plant's accumulated gross income from Year 2015 to 2040
d—Shaded area is accumulated net income at any time of plant's life. At 2040 (end life), the accumulated net income well be $42,740,000.—At end of the plant's life.

1. The Solar Chlorine Producing Module, “SCPM”, is an invention by integrating nonrelated existing science fields to develop a commercial producing chlorine unit. This invention brings the science of universities' class rooms to state of productivity in chemical industries. The prime motivations for invention of “SCPM” are solar power, energy conservation, environmental protection, and lowering overall cost.
The “SCPM”, of claim 1 is designed to produced annually 50 tons of chlorine, 56.5 tons of pure caustic soda, and 1.4 tons of hydrogen. The “SCPM”, annually will use 125,000 kWh solar power and 83 tons of pure table salt.
The importance of “SCPM” invention can be better realized, when in the list of top fifteen products of chemical industries in U.S. and world, caustic soda ranks number nine, chlorine ranks number 10, and together rank number three.
The Solar Chlorine Producing Module, “SCPM”, of claim 1 is developed as commercial producing chlorine unit with lowest energy used per ton of chlorine, minimum maintenance cost, and low capital cost. “SCPM” can pay off its initial capital cost in six years with annual return rate of 16.6%.

1. The “SCPM” of claim 1, in contrast with existing chlorine plants, is independent from power utility networks. It generates the power needs by its “Solar Power producer”.

2. In solar power producer of “SCPM” claim 1, the solar irradiation capture is made of N frames, and in this case N is 64 frames that arranged as eight columns of eight frames, making maintenance and troubleshooting easy. Electrically all frames are connected in parallel.

3. Each Solar Frame of power assembly has four commercial solar panels. From wide spectrum of solar panels with different efficiencies and costs, by optimization method, the best in market that generate more power with less cost has been selected. The solar panel in “SCPM” is Crystalline Silicon Model “LG265 Si—C 265 G3” with dimension of 65″×40″×1.4″ and efficiency of 16.6%. Panel produces 270 watts AC power, with 31.4 volts and 8.46 Amps. Panel manufacturer is “MONOX” and it is mass product and stock item.

4. The “solar power producer” of “SCPM” claim 1 has out pot of 68 KW DC power with 31.4 volts and 2200 Amps.

5. The chlorine producing unit “C12 unit” of “SCPM” of claim 1, is membrane cell that has lowest energy use per ton of chlorine and its solar power source causes less CO2 releases to air and can be accepted as environmental cleaner, while the mercury cell and diaphragm cell are environmental plotters, as they use power from utility networks and release mercury and asbestos to environment.

6. The Cl2 unit is made of M number of cells. The “SCPM” of claim 1 has nine cells. Electrically connected in series parallel. Cells are PVC slim cylinders with 8 inches in diameter and 60 inches tall to maximize the ion capture area of cathode and minimize the travelling path of ions to reduce the electrolysis energy. A membrane cylinder of 4 inches diameter separate cathode from anode. Each cell operates with 3-3.3 voltage and 2200 Amps. Cells are electrically connected in series, but their product piping lines are connected in parallel.

7. The “SCPM” of claim 1 is the most economical commercial chlorine producing unit. Its initial capital cost is fraction of conventional units due to elimination of power installation to convert high voltage AC power to very low voltage DC power, as well as elimination of special storage and processes such as purification, liquidation, bottling and transportation.

8. The “SCPM” of claim 1 as a commercial chlorine producing unit has the lowest annual running cost and maintenance cost, it uses free energy and assembly is simple and trouble free.

9. The “SCPM” of claim 1 is environmentally friendly, in contrast to existing traditional chlorine facilities. No restriction would be applied by EPA for its site selection and it can be built anywhere.

10. It could be marketed as shelf items.
